(19) United States
(12) Patent Application Publication
(10) Pub. No.: US 2025/0368556 A1
(43) Pub. Date: Dec. 4, 2025

(54) Chemical Dosing of Dynamic Membrane Systems and Methods Thereof

(71) Applicant: Xylem Water Solutions Zelienople LLC, Zelienople, PA (US)

(72) Inventor: Wenjun Liu, Mars, PA (US)

(21) Appl. No.: 18/871,985

(22) PCT Filed: Jun. 6, 2023
(86) PCT No.: PCT/US23/24506

§ 371 Date: Dec. 5, 2024

Related U.S. Application Data
(60) Provisional application No. 63/350,061, filed on Jun. 8, 2022.

(51) Int. Cl. C02F 9/00; B01D 69/10; C02F 1/68; C02F 3/12

(52) U.S. Cl. CPC C02F 9/00; B01D 69/10; C02F 1/68; C02F 3/1268; C02F 2203/006

(57) ABSTRACT

A solid-liquid separation system configured to produce a filtrate includes an inlet zone configured to receive a solid-liquid slurry; a filter including a dynamic membrane, the dynamic membrane including a liquid-permeable supporting element having a first face, a second face opposite of the first face, and a pore size of greater than 1 micron; a first transfer stream in fluid communication with the filter and configured to transport the filtrate to external from the filter; and a mechanism for adding a chemical additive to the solid-liquid slurry in the solid-liquid separation system.

### CROSS-REFERENCE TO RELATED APPLICATIONS

This application is the United States national phase of International Patent Application No. PCT/US23/24506, filed Jun. 6, 2023, and claims to benefit of U.S. Provisional Patent Application No. 63/350,061, filed Jun. 8, 2022, the disclosures of which are hereby incorporated by reference in their entireties.

### BACKGROUND OF THE INVENTION

### Field of the Invention

The present invention relates to dynamic membrane systems, and particularly to systems and methods for producing a filtrate.

### Description of Related Art

Membrane filtration techniques have been previously implemented for solid and liquid separation. Microfiltration and ultrafiltration membranes, both of which having pore sizes less than 1 micron, are commonly used as filtration membranes. However, due to their complex manufacturing, microfiltration and ultrafiltration membranes prices are exorbitant. Further, the small pore size of microfiltration and ultrafiltration membranes results in a low membrane flux or typically less than 50 liters per square meter per hour (L/m² h), thereby requiring an extremely large membrane surface to treat the millions of gallons of water seen per day by membrane filtration systems. Thus, the capital expenditure for microfiltration and ultrafiltration membrane systems are very high.

To decrease the cost of these membrane systems, some have used higher porous materials for solid-liquid separation. While higher porous material membranes will have a high initial flux, the large pores allow many more suspended solids to pass through the membrane, resulting in a poor filtrate. Further, the deposition of solids onto the membrane will aid in decreasing the total suspended solids in the filtrate, but will also decrease the flux through the membrane. Therefore, there is a trade-off between an acceptable flux and an acceptable level of suspended solids in the final filtrate.

As such, there is a current need in the art for a membrane filtration system and method that results in an acceptably low level of total suspended solids in the final filtrate without compromising the flux through the membrane.

### SUMMARY OF THE INVENTION

The present invention is directed to a solid-liquid separation system configured to produce a filtrate including: an inlet zone configured to receive a solid-liquid slurry; a filter including a dynamic membrane, the dynamic membrane including: a liquid-permeable supporting element having a first face, a second face opposite of the first face, and a pore size of greater than 1 micron; a first transfer stream in fluid communication with the filter and configured to transport the filtrate to external from the filter; and a mechanism for adding a chemical additive to the solid-liquid slurry in the solid-liquid separation system.

The dynamic membrane may further include a cake layer of deposited solids over at least a portion of the first face of the liquid-permeable supporting element. The solid-liquid slurry may be water with solid particles, wastewater with solid particles, mixed liquor in activated sludge system, sludge from water treatment systems, or sludge from wastewater treatment systems. The solid-liquid separation system may further include: a bioreactor configured to receive the solid-liquid slurry from the inlet zone; a second transfer stream in fluid communication with the bioreactor and the filter and configured to transport the solid-liquid slurry from the bioreactor to the filter; and a first recycle stream in fluid communication with the bioreactor and the filter and configured to transport at least a portion of the solid-liquid slurry from the filter back to the bioreactor; where the mechanism for adding the chemical additive adds the chemical additive to the solid-liquid slurry at the inlet zone, the bioreactor, the filter, the second transfer stream, and/or the first recycle stream. The solid-liquid separation system may further include: a bioreactor configured to receive the solid-liquid slurry from the inlet zone; a second transfer stream in fluid communication with the bioreactor and the filter and configured to transport the solid-liquid slurry from the bioreactor to the filter; a first recycle stream in fluid communication with the bioreactor and the filter and configured to transport at least a portion of the solid-liquid slurry from the filter back to the bioreactor; a solids water separation unit configured to produce a solid lean stream; a third transfer stream in fluid communication with the bioreactor and the solids water separation unit and configured to transport at least a portion of the solid-liquid slurry in the bioreactor to the solids water separation unit; a second recycle stream in fluid communication with the solids water separation unit and the bioreactor and configured to transport at least a portion of the solid-liquid slurry in the filter back to the bioreactor; and a fourth transfer stream in fluid communication with the solids water separation unit and configured to transport the solid lean stream to external of the solids water separation unit; where the mechanism for adding the chemical additive adds the chemical additive to the solid-liquid slurry at the inlet zone, the bioreactor, the filter, the solids water separation unit, the second transfer stream, the third transfer stream, the first recycle stream, and/or the second recycle stream. The solid-liquid separation system may further include: a bioreactor configured to receive the solid-liquid slurry from the inlet zone; a first recycle stream in fluid communication with the filter and the bioreactor and configured to transport at least a portion of the solid-liquid slurry in the filter back to the bioreactor; a solids water separation unit, where a first portion of solids within the solid-liquid slurry sinks to the bottom of the solids water separation unit and a second portion of solids within the solid-liquid slurry floats in the solid-liquid slurry in the solids water separation unit; a second transfer stream in fluid communication with the bioreactor and the solid water separation unit and configured to transport the solid-liquid slurry from the bioreactor to the solid water separation unit; a second recycle stream in fluid communication with the bioreactor and the solids water separation unit and configured to transport at least a portion of the solid-liquid slurry from the solids water separation unit back to the bioreactor; and a third transfer stream in fluid communication with the solids water separation unit and the filter and configured to transport at least a portion of the solid-liquid slurry from the solids water separation unit to the filter. The mechanism for adding the chemical additive may add the chemical additive to the solid-liquid slurry at the inlet zone, the bioreactor, the filter, the solids water separation unit, the second transfer stream, the third transfer stream, the first recycle stream, and/or the second recycle stream. The solid-liquid separation system may further include: a bioreactor configured to receive the solid-liquid slurry from the inlet zone; where the bioreactor and the filter are included in the same tank. The solid-liquid separation system may further include: a solids water separation unit configured to produce a solid lean stream; a second transfer stream in fluid communication with the bioreactor and the solids water separation unit and configured to transport at least a portion of the solid-liquid slurry in the bioreactor to the solids water separation unit; a first recycle stream in fluid communication with the solids water separation unit and the bioreactor and configured to transport at least a portion of the solid-liquid slurry in the filter back to the bioreactor; and a third transfer stream in fluid communication with the solids water separation unit and configured to transport the solid lean stream to external of the solids water separation unit; where the mechanism for adding the chemical additive adds the chemical additive to the solid-liquid stream at the inlet zone, the bioreactor, the filter, the solids water separation unit, the second transfer stream, and/or the first recycle stream. The chemical additive may include a polymer. The polymer may include a cationic polymer. The cationic polymer may have a molecular weight of greater than 20,000 g/mol. The cationic polymer may have a molecular weight of greater than 100,000 g/mol. The cationic polymer may have a molecular weight of greater than 300,000 g/mol. The cationic polymer may include polydiallyldimethylammonium chloride. The mechanism for adding the chemical additive may be configured to add the chemical additive to increase the flux across the dynamic membrane to at least 500 L/m² h. The mechanism for adding the chemical additive may be configured to add the chemical additive to increase the flux across the dynamic membrane to at least 750 L/m² h. The mechanism for adding the chemical additive may be configured to add the chemical additive to increase the flux across the dynamic membrane to at least 1,000 L/m² h. The mechanism for adding the chemical additive may be configured to add the chemical additive to increase the flux across the dynamic membrane to at least 1,250 L/m² h. The mechanism for adding the chemical additive may be configured to add the chemical additive to increase the flux across the dynamic membrane to at least 1,500 L/m² h. The mechanism for adding the chemical additive may be configured to add the chemical additive to decrease the total suspended solids in the filtrate to less than 20 mg/L. The mechanism for adding the chemical additive may be configured to add the chemical additive to decrease the total suspended solids in the filtrate to less than 10 mg/L. The mechanism for adding the chemical additive may be configured to add the chemical additive to decrease the total suspended solids in the filtrate to less than 5 mg/L. The mechanism for adding the chemical additive may be configured to add less than 100 mg/L of chemical additive to the solid-liquid slurry in the solid-liquid separation system. The mechanism for adding the chemical additive may be configured to add less than 50 mg/L of chemical additive to the solid-liquid slurry in the solid-liquid separation system. The mechanism for adding the chemical additive may be configured to add less than 25 mg/L of chemical additive to the solid-liquid slurry in the solid-liquid separation system. The mechanism for adding the chemical additive may be configured to add less than 12.5 mg/L of chemical additive to the solid-liquid slurry in the solid-liquid separation system. The mechanism for adding the chemical additive may be configured to add less than 6 mg/L of chemical additive to the solid-liquid slurry in the solid-liquid separation system. The pore size of the liquid-permeable supporting element may be larger than 5 microns. The pore size of the liquid-permeable supporting element may be larger than 10 microns.

The present invention is also directed to a method to produce a filtrate from a solid-liquid slurry, the steps including: introducing a solid-liquid slurry into an inlet zone; transporting the solid-liquid slurry to a filter comprising a dynamic membrane, the dynamic membrane including: a liquid-permeable supporting element having a first face, a second face opposite of the first face, and a pore size of greater than 1 micron, and a cake layer of deposited solids over at least a portion of the first face of the liquid permeable-supporting element; filtering the solid-liquid slurry with the dynamic membrane to produce a filtrate; transporting the filtrate in a first transfer stream to external of the filter; and adding a chemical additive to the solid-liquid slurry at some point prior to the filtering.

The transporting the solid-liquid slurry the filter step may further include: transporting the solid-liquid slurry from the inlet zone to a bioreactor; and transporting the solid-liquid slurry from the bioreactor to the filter. The method may further include: transporting at least a portion of the solid-liquid slurry in the filter back to the bioreactor in a first recycle stream; where the transporting the solid-liquid slurry from the bioreactor to the filter step comprises transporting the solid-liquid slurry from the bioreactor to the filter in a second transfer stream; and where the adding the chemical additive step comprises adding the chemical additive to the solid-liquid slurry at the inlet zone, the bioreactor, the filter, the first recycle stream, and/or the second transfer stream. The method may further include: transporting at least a portion of the solid-liquid slurry in the filter back to the bioreactor in a first recycle stream, and where the transporting the solid-liquid slurry from the bioreactor to the filter step comprises transporting the solid-liquid slurry from the bioreactor to the filter in a second transfer stream; transporting at least a portion of the solid-liquid slurry in the bioreactor to a solids water separation unit in a third transfer stream; separating the solid-liquid slurry in the solids water separation unit to produce a solid lean stream; transporting the solid lean stream to external of the solids water separation unit in a fourth transfer stream; and transporting at least a portion of the solid-liquid slurry in the solids water separation unit back to the bioreactor in a second recycle stream; where the adding the chemical additive step comprises adding the chemical additive to the solid-liquid slurry at the inlet zone, the bioreactor, the filter, the solids water separation unit, the first recycle stream, the second recycle stream, the second transfer stream, and/or the third transfer stream. The method may further include: transporting the solid-liquid slurry from the inlet zone to a bioreactor; transporting the solid-liquid slurry from the bioreactor to a solids water separation unit in a second transfer stream; separating the solid-liquid slurry in the solids water separation unit into a first portion of solids that sinks to a bottom of the solids water separation unit and a second portion of solids that floats at a top of the solids water separation unit; transporting at least a portion of the solid-liquid slurry in the solids water separation unit to the filter in a third transfer stream; transporting at least a portion of the solid-liquid slurry in the filter back to the bioreactor in a first recycle stream; and transporting at least a portion of the solid-liquid slurry in the solids water separation unit back to the bioreactor in a second recycle stream. The adding the chemical additive step may include adding the chemical additive to the solid-liquid slurry at the inlet zone, the bioreactor, the filter, the solids water separation unit, the second transfer stream, the third transfer stream, the first recycle stream, and/or the second recycle stream. The method may further include providing the bioreactor and the filter in the same tank. The method may further include: transporting at least a portion of the solid-liquid slurry in the bioreactor to a solids water separation unit in a second transfer stream; separating the solid-liquid slurry in the solids water separation unit to produce a solid lean stream; transporting at least a portion of the solid-liquid slurry in the solids water separation unit back to the bioreactor in a first recycle stream; and transporting the solid lean stream from the solids water separation unit to external of the solids water separation unit in a second transfer stream; where the adding the chemical additive step includes adding the chemical additive to the solid-liquid slurry at the inlet zone, the bioreactor, the filter, the solids water separation unit, the second transfer stream; and/or the first recycle stream. The chemical additive may include a polymer. The polymer may include a cationic polymer. The cationic polymer may have a molecular weight of greater than 20,000 g/mol. The cationic polymer may have a molecular weight of greater than 100,000 g/mol. The cationic polymer may have a molecular weight of greater than 300,000 g/mol. The cationic polymer may include polydiallyldimethylammonium chloride. The adding the chemical additive to the solid-liquid slurry step may include adding the chemical additive to the solid-liquid slurry to increase the flux across the dynamic membrane to at least 500 L/m² h. The adding the chemical additive to the solid-liquid slurry step may include adding the chemical additive to the solid-liquid slurry to increase the flux across the dynamic membrane to at least 750 L/m² h. The adding the chemical additive to the solid-liquid slurry step may include adding the chemical additive to the solid-liquid slurry to increase the flux across the dynamic membrane to at least 1,000 L/m² h. The adding the chemical additive to the solid-liquid slurry step may include adding the chemical additive to the solid-liquid slurry to increase the flux across the dynamic membrane to at least 1,250 L/m² h. The adding the chemical additive to the solid-liquid slurry step may include adding the chemical additive to the solid-liquid slurry to increase the flux across the dynamic membrane to at least 1,500 L/m² h. The adding the chemical additive to the solid-liquid slurry step may include adding the chemical additive to the solid-liquid slurry to decrease the total suspended solids in the filtrate to less than 20 mg/L. The adding the chemical additive to the solid-liquid slurry step may include adding the chemical additive to the solid-liquid slurry to decrease the total suspended solids in the filtrate to less than 10 mg/L. The adding the chemical additive to the solid-liquid slurry step may include adding the chemical additive to the solid-liquid slurry to decrease the total suspended solids in the filtrate to less than 5 mg/L. The adding the chemical additive to the solid-liquid slurry step may include adding less than 100 mg/L of chemical additive to the solid-liquid slurry. The adding the chemical additive to the solid-liquid slurry step may include adding less than 50 mg/L of chemical additive to the solid-liquid slurry. The adding the chemical additive to the solid-liquid slurry step may include adding less than 25 mg/L of chemical additive to the solid-liquid slurry. The adding the chemical additive to the solid-liquid slurry step may include adding less than 12.5 mg/L of chemical additive to the solid-liquid slurry. The adding the chemical additive to the solid-liquid slurry step may include adding less than 6 mg/L of chemical additive to the solid-liquid slurry. The pore size of the liquid-permeable supporting element may be larger than 5 microns. The pore size of the liquid-permeable supporting element may be larger than 10 microns.

The present invention further includes the subject matter of the following clauses.

Clause 1: A solid-liquid separation system configured to produce a filtrate, comprising: an inlet zone configured to receive a solid-liquid slurry; a filter comprising a dynamic membrane, the dynamic membrane comprising: a liquid-permeable supporting element having a first face, a second face opposite of the first face, and a pore size of greater than 1 micron; a first transfer stream in fluid communication with the filter and configured to transport the filtrate to external from the filter; and a mechanism for adding a chemical additive to the solid-liquid slurry in the solid-liquid separation system.

Clause 2: The solid-liquid separation system of clause 1, wherein the dynamic membrane further comprises a cake layer of deposited solids over at least a portion of the first face of the liquid-permeable supporting element.

Clause 3: The solid-liquid separation system of clause 1 or 2, wherein the solid-liquid slurry is water with solid particles, wastewater with solid particles, mixed liquor in activated sludge system, sludge from water treatment systems, or sludge from wastewater treatment systems.

Clause 4: The solid-liquid separation system of any of clauses 1-3, further comprising: a bioreactor configured to receive the solid-liquid slurry from the inlet zone; a second transfer stream in fluid communication with the bioreactor and the filter and configured to transport the solid-liquid slurry from the bioreactor to the filter; and a first recycle stream in fluid communication with the bioreactor and the filter and configured to transport at least a portion of the solid-liquid slurry from the filter back to the bioreactor; wherein the mechanism for adding the chemical additive adds the chemical additive to the solid-liquid slurry at the inlet zone, the bioreactor, the filter, the second transfer stream, and/or the first recycle stream.

Clause 5: The solid-liquid separation system of any of clauses 1-3, further comprising: a bioreactor configured to receive the solid-liquid slurry from the inlet zone; a second transfer stream in fluid communication with the bioreactor and the filter and configured to transport the solid-liquid slurry from the bioreactor to the filter; a first recycle stream in fluid communication with the bioreactor and the filter and configured to transport at least a portion of the solid-liquid slurry from the filter back to the bioreactor; a solids water separation unit configured to produce a solid lean stream; a third transfer stream in fluid communication with the bioreactor and the solids water separation unit and configured to transport at least a portion of the solid-liquid slurry in the bioreactor to the solids water separation unit; a second recycle stream in fluid communication with the solids water separation unit and the bioreactor and configured to transport at least a portion of the solid-liquid slurry in the filter back to the bioreactor; and a fourth transfer stream in fluid communication with the solids water separation unit and configured to transport the solid lean stream to external of the solids water separation unit; wherein the mechanism for adding the chemical additive adds the chemical additive to the solid-liquid slurry at the inlet zone, the bioreactor, the filter, the solids water separation unit, the second transfer stream, the third transfer stream, the first recycle stream, and/or the second recycle stream.

Clause 6: The solid-liquid separation system of any of clauses 1-3, further comprising: a bioreactor configured to receive the solid-liquid slurry from the inlet zone; a first recycle stream in fluid communication with the filter and the bioreactor and configured to transport at least a portion of the solid-liquid slurry in the filter back to the bioreactor; a solids water separation unit, wherein a first portion of solids within the solid-liquid slurry sinks to the bottom of the solids water separation unit and a second portion of solids within the solid-liquid slurry floats in the solid-liquid slurry in the solids water separation unit; a second transfer stream in fluid communication with the bioreactor and the solid water separation unit and configured to transport the solid-liquid slurry from the bioreactor to the solid water separation unit; a second recycle stream in fluid communication with the bioreactor and the solids water separation unit and configured to transport at least a portion of the solid-liquid slurry from the solids water separation unit back to the bioreactor; and a third transfer stream in fluid communication with the solids water separation unit and the filter and configured to transport at least a portion of the solid-liquid slurry from the solids water separation unit to the filter.

Clause 7: The solid-liquid separation system of clause 6, wherein the mechanism for adding the chemical additive adds the chemical additive to the solid-liquid slurry at the inlet zone, the bioreactor, the filter, the solids water separation unit, the second transfer stream, the third transfer stream, the first recycle stream, and/or the second recycle stream.

Clause 8: The solid-liquid separation system of any of clauses 1-3, further comprising: a bioreactor configured to receive the solid-liquid slurry from the inlet zone; wherein the bioreactor and the filter are included in the same tank.

Clause 9: The solid-liquid separation system of clause 8, further comprising: a solids water separation unit configured to produce a solid lean stream; a second transfer stream in fluid communication with the bioreactor and the solids water separation unit and configured to transport at least a portion of the solid-liquid slurry in the bioreactor to the solids water separation unit; a first recycle stream in fluid communication with the solids water separation unit and the bioreactor and configured to transport at least a portion of the solid-liquid slurry in the filter back to the bioreactor; and a third transfer stream in fluid communication with the solids water separation unit and configured to transport the solid lean stream to external of the solids water separation unit; wherein the mechanism for adding the chemical additive adds the chemical additive to the solid-liquid stream at the inlet zone, the bioreactor, the filter, the solids water separation unit, the second transfer stream, and/or the first recycle stream.

Clause 10: The solid-liquid separation system of any of clauses 1-9, wherein the chemical additive comprises a polymer.

Clause 11: The solid-liquid separation system of clause 10, wherein the polymer comprises a cationic polymer.

Clause 12: The solid-liquid separation system of clause 11, wherein the cationic polymer has a molecular weight of greater than 20,000 g/mol.

Clause 13: The solid-liquid separation system of clause 11 or 12, wherein the cationic polymer has a molecular weight of greater than 100,000 g/mol.

Clause 14: The solid-liquid separation system of any of clauses 11-13, wherein the cationic polymer has a molecular weight of greater than 300,000 g/mol.

Clause 15: The solid-liquid separation system of any of clauses 11-14, wherein the cationic polymer comprises polydiallyldimethylammonium chloride.

Clause 16: The solid-liquid separation system of any of clauses 1-15, wherein the mechanism for adding the chemical additive is configured to add the chemical additive to increase the flux across the dynamic membrane to at least 500 L/m² h.

Clause 17: The solid-liquid separation system of any of clauses 1-16, wherein the mechanism for adding the chemical additive is configured to add the chemical additive to increase the flux across the dynamic membrane to at least 750 L/m² h.

Clause 18: The solid-liquid separation system of any of clauses 1-17, wherein the mechanism for adding the chemical additive is configured to add the chemical additive to increase the flux across the dynamic membrane to at least 1,000 L/m² h.

Clause 19: The solid-liquid separation system of any of clauses 1-18, wherein the mechanism for adding the chemical additive is configured to add the chemical additive to increase the flux across the dynamic membrane to at least 1,250 L/m² h.

Clause 20: The solid-liquid separation system of any of clauses 1-19, wherein the mechanism for adding the chemical additive is configured to add the chemical additive to increase the flux across the dynamic membrane to at least 1,500 L/m² h.

Clause 21: The solid-liquid separation system of any of clauses 1-20, wherein the mechanism for adding the chemical additive is configured to add the chemical additive to decrease the total suspended solids in the filtrate to less than 20 mg/L.

Clause 22: The solid-liquid separation system of any of clauses 1-21, wherein the mechanism for adding the chemical additive is configured to add the chemical additive to decrease the total suspended solids in the filtrate to less than 10 mg/L.

Clause 23: The solid-liquid separation system of any of clauses 1-22, wherein the mechanism for adding the chemical additive is configured to add the chemical additive to decrease the total suspended solids in the filtrate to less than 5 mg/L.

Clause 24: The solid-liquid separation system of any of clauses 1-23, wherein the mechanism for adding the chemical additive is configured to add less than 100 mg/L of chemical additive to the solid-liquid slurry in the solid-liquid separation system.

Clause 25: The solid-liquid separation system of any of clauses 1-24, wherein the mechanism for adding the chemical additive is configured to add less than 50 mg/L of chemical additive to the solid-liquid slurry in the solid-liquid separation system.

Clause 26: The solid-liquid separation system of any of clauses 1-25, wherein the mechanism for adding the chemical additive is configured to add less than 25 mg/L of chemical additive to the solid-liquid slurry in the solid-liquid separation system.

Clause 27: The solid-liquid separation system of any of clauses 1-26, wherein the mechanism for adding the chemical additive is configured to add less than 12.5 mg/L of chemical additive to the solid-liquid slurry in the solid-liquid separation system.

Clause 28: The solid-liquid separation system of any of clauses 1-27, wherein the mechanism for adding the chemical additive is configured to add less than 6 mg/L of chemical additive to the solid-liquid slurry in the solid-liquid separation system.

Clause 29: The solid-liquid separation system of any of clauses 1-28, wherein the pore size of the liquid-permeable supporting element is larger than 5 microns.

Clause 30: The solid-liquid separation system of any of clauses 1-29, wherein the pore size of the liquid-permeable supporting element is larger than 10 microns.

Clause 31: A method to produce a filtrate from a solid-liquid slurry, the steps comprising: introducing a solid-liquid slurry into an inlet zone; transporting the solid-liquid slurry to a filter comprising a dynamic membrane, the dynamic membrane comprising: a liquid-permeable supporting element having a first face, a second face opposite of the first face, and a pore size of greater than 1 micron, and a cake layer of deposited solids over at least a portion of the first face of the liquid permeable-supporting element; filtering the solid-liquid slurry with the dynamic membrane to produce a filtrate; transporting the filtrate in a first transfer stream to external of the filter; and adding a chemical additive to the solid-liquid slurry at some point prior to the filtering.

Clause 32: The method of clause 31, wherein the transporting the solid-liquid slurry the filter step further comprises: transporting the solid-liquid slurry from the inlet zone to a bioreactor; and transporting the solid-liquid slurry from the bioreactor to the filter.

Clause 33: The method of clause 32, further comprising: transporting at least a portion of the solid-liquid slurry in the filter back to the bioreactor in a first recycle stream; wherein the transporting the solid-liquid slurry from the bioreactor to the filter step comprises transporting the solid-liquid slurry from the bioreactor to the filter in a second transfer stream; and wherein the adding the chemical additive step comprises adding the chemical additive to the solid-liquid slurry at the inlet zone, the bioreactor, the filter, the first recycle stream, and/or the second transfer stream.

Clause 34: The method of clause 32, further comprising: transporting at least a portion of the solid-liquid slurry in the filter back to the bioreactor in a first recycle stream, and wherein the transporting the solid-liquid slurry from the bioreactor to the filter step comprises transporting the solid-liquid slurry from the bioreactor to the filter in a second transfer stream; transporting at least a portion of the solid-liquid slurry in the bioreactor to a solids water separation unit in a third transfer stream; separating the solid-liquid slurry in the solids water separation unit to produce a solid lean stream; transporting the solid lean stream to external of the solids water separation unit in a fourth transfer stream; and transporting at least a portion of the solid-liquid slurry in the solids water separation unit back to the bioreactor in a second recycle stream; wherein the adding the chemical additive step comprises adding the chemical additive to the solid-liquid slurry at the inlet zone, the bioreactor, the filter, the solids water separation unit, the first recycle stream, the second recycle stream, the second transfer stream, and/or the third transfer stream.

Clause 35: The method of clause 31, further comprising: transporting the solid-liquid slurry from the inlet zone to a bioreactor; transporting the solid-liquid slurry from the bioreactor to a solids water separation unit in a second transfer stream; separating the solid-liquid slurry in the solids water separation unit into a first portion of solids that sinks to a bottom of the solids water separation unit and a second portion of solids that floats at a top of the solids water separation unit; transporting at least a portion of the solid-liquid slurry in the solids water separation unit to the filter in a third transfer stream; transporting at least a portion of the solid-liquid slurry in the filter back to the bioreactor in a first recycle stream; and transporting at least a portion of the solid-liquid slurry in the solids water separation unit back to the bioreactor in a second recycle stream.

Clause 36: The method of clause 35, wherein the adding the chemical additive step comprises adding the chemical additive to the solid-liquid slurry at the inlet zone, the bioreactor, the filter, the solids water separation unit, the second transfer stream, the third transfer stream, the first recycle stream, and/or the second recycle stream.

Clause 37: The method of clause 32, further comprising providing the bioreactor and the filter in the same tank.

Clause 38: The method of clause 37, further comprising: transporting at least a portion of the solid-liquid slurry in the bioreactor to a solids water separation unit in a second transfer stream; separating the solid-liquid slurry in the solids water separation unit to produce a solid lean stream; transporting at least a portion of the solid-liquid slurry in the solids water separation unit back to the bioreactor in a first recycle stream; and transporting the solid lean stream from the solids water separation unit to external of the solids water separation unit in a second transfer stream; wherein the adding the chemical additive step comprises adding the chemical additive to the solid-liquid slurry at the inlet zone, the bioreactor, the filter, the solids water separation unit, the second transfer stream; and/or the first recycle stream.

Clause 39: The method of any of clauses 31-38, wherein the chemical additive comprises a polymer.

Clause 40: The method of clause 39, wherein the polymer comprises a cationic polymer.

Clause 41: The method of clause 40, wherein the cationic polymer has a molecular weight of greater than 20,000 g/mol.

Clause 42: The method of clause 40 or 41, wherein the cationic polymer has a molecular weight of greater than 100,000 g/mol.

Clause 43: The method of any of clauses 40-42, wherein the cationic polymer has a molecular weight of greater than 300,000 g/mol.

Clause 44: The method of any of clauses 40-43, wherein the cationic polymer comprises polydiallyldimethylammonium chloride.

Clause 45: The method of any of clauses 31-44, wherein the adding the chemical additive to the solid-liquid slurry step comprises adding the chemical additive to the solid-liquid slurry to increase the flux across the dynamic membrane to at least 500 L/m² h.

Clause 46: The method of any of clauses 31-45, wherein the adding the chemical additive to the solid-liquid slurry step comprises adding the chemical additive to the solid-liquid slurry to increase the flux across the dynamic membrane to at least 750 L/m² h.

Clause 47: The method of any of clauses 31-46, wherein the adding the chemical additive to the solid-liquid slurry step comprises adding the chemical additive to the solid-liquid slurry to increase the flux across the dynamic membrane to at least 1,000 L/m² h.

Clause 48: The method of any of clauses 31-47, wherein the adding the chemical additive to the solid-liquid slurry step comprises adding the chemical additive to the solid-liquid slurry to increase the flux across the dynamic membrane to at least 1,250 L/m² h.

Clause 49: The method of any of clauses 31-48, wherein the adding the chemical additive to the solid-liquid slurry step comprises adding the chemical additive to the solid-liquid slurry to increase the flux across the dynamic membrane to at least 1,500 L/m² h.

Clause 50: The method of any of clauses 31-49, wherein the adding the chemical additive to the solid-liquid slurry step comprises adding the chemical additive to the solid-liquid slurry to decrease the total suspended solids in the filtrate to less than 20 mg/L.

Clause 51: The method of any of clauses 31-50, wherein the adding the chemical additive to the solid-liquid slurry step comprises adding the chemical additive to the solid-liquid slurry to decrease the total suspended solids in the filtrate to less than 10 mg/L.

Clause 52: The method of any of clauses 31-51, wherein the adding the chemical additive to the solid-liquid slurry step comprises adding the chemical additive to the solid-liquid slurry to decrease the total suspended solids in the filtrate to less than 5 mg/L.

Clause 53: The method of any of clauses 31-52, wherein the adding the chemical additive to the solid-liquid slurry step comprises adding less than 100 mg/L of chemical additive to the solid-liquid slurry.

Clause 54: The method of any of clauses 31-53, wherein the adding the chemical additive to the solid-liquid slurry step comprises adding less than 50 mg/L of chemical additive to the solid-liquid slurry.

Clause 55: The method of any of clauses 31-54, wherein the adding the chemical additive to the solid-liquid slurry step comprises adding less than 25 mg/L of chemical additive to the solid-liquid slurry.

Clause 56: The method of any of clauses 31-55, wherein the adding the chemical additive to the solid-liquid slurry step comprises adding less than 12.5 mg/L of chemical additive to the solid-liquid slurry.

Clause 57: The method of any of clauses 31-56, wherein the adding the chemical additive to the solid-liquid slurry step comprises adding less than 6 mg/L of chemical additive to the solid-liquid slurry.

Clause 58: The method of any of clauses 31-57, wherein the pore size of the liquid-permeable supporting element is larger than 5 microns.

Clause 59: The method of any of clauses 31-58, wherein the pore size of the liquid-permeable supporting element is larger than 10 microns.

Clause 60: A solid-liquid separation system configured to produce a filtrate, comprising: an inlet zone configured to receive a solid-liquid slurry; a tank configured to receive the solid-liquid slurry from the inlet zone; a filter comprising a dynamic membrane, the dynamic membrane comprising: a liquid-permeable supporting element having a first face, a second face opposite of the first face, and a pore size of greater than 1 micron; a first transfer stream in fluid communication with the filter and configured to transport the filtrate to external from the filter; a second transfer stream in fluid communication with the tank and the filter and configured to transport the solid-liquid slurry from the tank to the filter; and a mechanism for adding a chemical additive to the solid-liquid slurry in the solid-liquid separation system.

Clause 61: The solid-liquid separation system of clause 60, wherein the tank comprises a bioreactor.

### BRIEF DESCRIPTION OF THE DRAWINGS

FIG. 1 is a schematic diagram of a solid-liquid separation system according to one aspect of the present invention;

FIG. 2 is a partial cross-sectional view of a filter according to another aspect of the present invention;

FIG. 3 is a schematic view of a plurality of liquid-permeable supporting elements arranged as a disc according to another aspect of the present invention;

FIG. 4 is a schematic view of a plurality of liquid-permeable supporting elements arranged as a drum according to another aspect of the present invention;

FIG. 5 is a schematic view of a filter according to another aspect of the present invention;

FIG. 6 is a schematic diagram of a solid-liquid separation system according to another aspect of the present invention;

FIG. 7 is a schematic diagram of a solid-liquid separation system according to another aspect of the present invention;

FIG. 8 is a schematic diagram of a solid-liquid separation system according to another aspect of the present invention;

FIG. 9 is a schematic diagram of a solid-liquid separation system according to another aspect of the present invention; and

FIG. 10 is a flow chart of a method to produce a filtrate from a solid-liquid slurry according to another aspect of the present invention.

### DESCRIPTION OF THE INVENTION

For purposes of the description hereinafter, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

All numbers used in the specification and claims are to be understood as being modified in all instances by the term “about.” The terms “approximately,” “about,” and “substantially” mean a range of plus or minus ten percent of the stated value.

In this application, the use of the singular includes the plural and the plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. Additionally, terminology such as “first”, “second”, “third”, etc. are included simply to identify individual components where multiple similar components are present and are not meant to be limiting on said individual component. For example, in one embodiment a “first” stream may be present between a first and second component, while in another embodiment a “first” stream may be present between a third and fourth component.

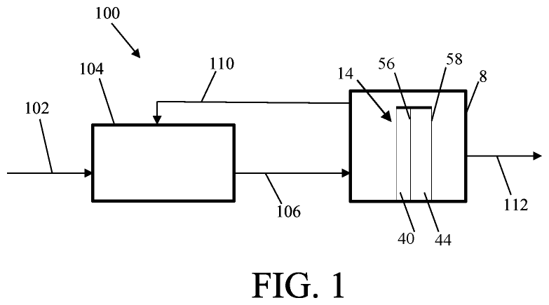

Referring to FIG. 1, a solid-liquid separation system 100 for producing a filtrate from a solid-liquid slurry is provided. A solid-liquid slurry enters the system from a source of a solid-liquid slurry to an inlet zone 102. A “solid-liquid slurry” refers to any distribution or disbursing of solid particles in a liquid medium. For example, the solid-liquid slurry can be water with solid particles, wastewater with solid particles, mixed liquor in activated sludge system, sludge from water treatment systems, or sludge from wastewater systems. As such, the system 100 may receive wastewater, or may not receive wastewater. As used herein, “solid particles” include the TSS content present in the solid-liquid slurry when in initially enters the system 100, “mixed liquor” includes the previously defined solid particles as well as biomass grown in the system 100 and biomass decay residues, and “sludge” includes the TSS that settles to the bottom of a sedimentation tank and is removed. For water with solid particles or wastewater with solid particles, the total suspended solids (TSS) of solid particles in the water or wastewater from a wastewater source are measured by filtering the waste or wastewater sample through a filter of 2.0 micron pore size or smaller. The filter is then dried in an oven between 103-105° C. for one hour and then the weight of dried solid particle residue is divided by the filtered sample volume to get the TSS of the water or wastewater with solid particles sample. For mixed liquor in an activated sludge system, when wastewater is treated in a biological activated sludge system, bacteria and other micro-organisms grow in the biological system. Various solids-water separation units can be used to concentrate the biomass in the bioreactor. The “mixed liquor” in such biological activated sludge systems include the original solid particles introduced to the system, the biomass grown in the system, and the biomass cell decay residuals. Since various solids-water separation units can be used to concentrate the biomass, the TSS concentration in mixed liquor is much higher than the TSS of the original water or wastewater. For example, a typical municipal wastewater TSS concentration is about 200 mg/L, while a TSS concentration of mixed liquor is about 4,000 mg/L. For sludge from water treatment systems, water treatment plants typically use various sedimentation tanks to remove the TSS in the water. The solid particles settle in the sedimentation tanks and therefore needs to be removed. The solid-liquid slurry that is removed from the bottom of the sediment tank in the water treatment system is referred to as sludge from the water treatment system. Similarly, for sludge from wastewater treatment systems, various solids-water separation units are used in wastewater treatment systems to concentrate a biomass. The solid-water separation unit may produce two streams: a solids lean stream which leaves the system as treated wastewater, and a solids rich stream, the majority of which may be recycled back to the bioreactor to increase the biomass concentration. A portion of the solids rich stream, such as 2-5% of the solids rich stream, can be removed from the biological wastewater treatment system. The small portion of the solid rich stream removed from the wastewater treatment system is referred to as sludge from the wastewater treatment system.

The solid-liquid slurry is commonly supplied to the inlet zone 102 from supply infrastructure in the ground. Said infrastructure and its corresponding piping network can be reused with minor upgrades to the pumping stations from the systems described herein. Other non-limiting examples of sources of solid-liquid slurry include municipal, industrial, and/or agricultural sources, such as, for example, municipal wastewater, water with solids from the oil, gas, or mining industry, solid-water separation in the food and beverage industry including the removal of yeast from beer, seawater for the removal of TSS to reduce fouling risk of reverse osmosis membrane and/or to concentrate algae.

Once the solid-liquid slurry enters the inlet zone 102 the solid-liquid slurry is subject to various processes. For example, the solid-liquid slurry may be subject to coarse screening to remove contaminants having a size of 20 mm or greater, followed by fine screening to remove contaminants having a size of 6 mm or greater. Further processing may include fat removal, which is not essential at the front end of the system, but may be retained if using a pre-existing plant that includes fat removal. The grit, sand, and other contaminants removed from the solid-liquid slurry in the inlet zone 102 may be disposed of by any conventional means, such as disposed of in a landfill. The inlet zone 102 may be free of any biological processes, such that no biological process take place in the inlet zone 102.

The solid-liquid slurry stream that exits the inlet zone 102 is considered pre-treated and is free of large debris and contaminants, but still contains dissolved organics, inorganics, and suspended solids. The solid-liquid slurry may contain various amounts of dissolved and/or suspended solids. For example, the solid-liquid slurry may include from 500-600 mg of chemical oxygen demand per liter (mgCOD/L), from 200-300 mg of biological oxygen demand per liter (mgBOD/L), from 40-60 mg of total Kjeldahl nitrogen, measured as elemental nitrogen, per liter (mgTKN-n/L), from 30-45 mg of ammonia, measured as elemental nitrogen, per liter (mgNH₄-n/L), from 100-400 mg of total suspended solids per liter (mgTSS/L), from 3-10 mg of total phosphorus per liter (mgTP/L), E. coli in an amount of greater than 106 colony forming units per 100 milliliters (CFU/100 mL), and/or fecal coliforms in an amount from 1700-5000/100 mL. These values are common levels of dissolved and/or suspended species in typical municipal sewage, but some other influent water streams can be outside these ranges. Industrial wastewater may or may not have amounts of dissolved and/or suspended species in the same ranges as above; however, may still be used in the systems defined herein. Other pathogens, such as Helminth eggs and/or virus materials, may be present depending on the geographic location and may also be removed in the current process. The solid-liquid slurry may be industrial or municipal wastewater. The solid-liquid slurry may include screen material having a size of less than 20 mm.

After the solid-liquid slurry leaves the inlet zone 102, the solid-liquid slurry may enter a bioreactor 104. The bioreactor 104 may include various biological processes. For example, the bioreactor may include an aerobic zone, an anoxic zone, and/or an anaerobic zone. The bioreactor 104 may include a single tank that includes one or more aerobic zone, an anoxic zone, and/or anaerobic zone. In some non-limiting embodiments, the inlet zone 102 may be included in the single tank of the bioreactor 104. The bioreactor 104 may include a plurality of tanks, where the aerobic zone, anoxic zone, and/or anaerobic zone are each provided in their own tank. The single tank or the plurality of tanks of the bioreactor 104 may be connected by piping, channel(s), port(s), and/or weir(s), to allow the solid-liquid slurry to exit each zone and enter the next zone.

After the solid-liquid slurry is subjected to the biological processes of the bioreactor 104, the solid-liquid slurry may be transported from the bioreactor 104 in a first transfer stream 106. The first transfer stream 106 may be in fluid communication with the bioreactor 104 and a filter 8, and configured to transport the solid-liquid slurry from the bioreactor 104 to the filter 8. In some non-limiting embodiments, the first transfer stream 106 may include a pump and a transfer pipe, channel, port, weir, and/or the like that aid in transporting the solid-liquid slurry from the bioreactor 104 to the filter 8. In some non-limiting embodiments, a height or pressure difference between the solid-liquid slurry in the bioreactor 104 and the solid-liquid slurry in the filter 8 may aid in transporting the solid-liquid slurry from the bioreactor 104 to the filter 8.

The first transfer steam 106 transports the solid-liquid slurry to a filter 8. The filter 8 may be configured to filter suspended solids and/or floc from the solid-liquid slurry to produce a filtrate and cake, as described below. As used herein, “floc” refers to conglomerated organic material suspended in the solid-liquid slurry. The filter 8 may be any filter known in the art. The filter 8 comprises a dynamic membrane 14. A dynamic membrane is a membrane that relies on the deposition of solids onto the membrane, thereby producing a layer of deposited solids or “cake” and increasing the flux through the dynamic membrane. The dynamic membrane 14 comprises a liquid-permeable supporting element 44. The liquid-permeable supporting element 44 has a pore size of greater than 1 micron, or greater than 2 microns, or greater than 3 microns, or greater than 4 microns, or greater than 5 microns, or greater than 8 microns, or greater than 10 microns. The liquid-permeable supporting element may have a pore size in the range of from greater than 1 micron to 50 microns, or from greater than 1 micron to 40 microns, or from 2 microns to 40 microns, or from 2 microns to 30 microns, or from 2 microns to 25 microns, or from 2 microns to 20 microns, or from 5 microns to 20 microns. The liquid-permeable supporting element 44 includes a first face 56 and a second face 58 opposite of the first face 56. The dynamic membrane 14 may further include a cake layer 40. The cake layer 40 is positioned on at least a portion of the first face 56 of the liquid-permeable supporting element 44. The cake layer 40 is formed from deposited solids of the solid-liquid slurry. While the solid-liquid slurry moves through the dynamic membrane 14, solids and/or floc of the solid-liquid slurry deliberately fouls the liquid-permeable supporting element 44, which begins to build a cake layer 40 on the first face 56 of the liquid-permeable supporting element 44. The size of the cake layer 40 may be controlled in order to maximize the flux through the dynamic membrane 14.

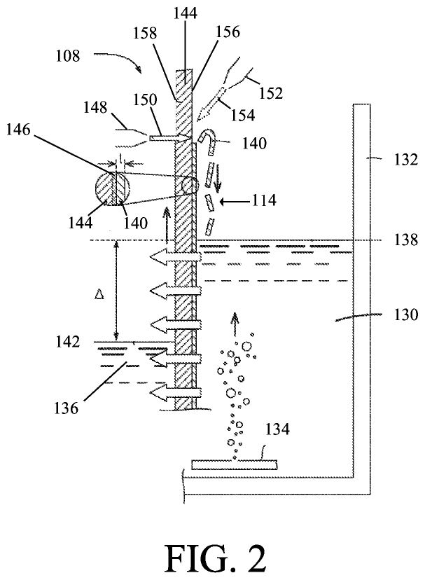

The filter 8 may be any filter 8 comprising a dynamic membrane 14 described herein or known in the art. According to certain non-limiting embodiments of the present invention, the processes and/or systems may include a filter 108 of FIGS. 2-5, such as a filtering/thickening machine (FTM). One possible version of the FTM is substantially described in Italian Patent Application Numbers 102018000010259, filed Nov. 12, 2018; 102018000010430, filed Nov. 19, 2018; 102019000011046, filed Jul. 5, 2019; and 102019000011058, filed Jul. 5, 2019. A preferred non-limiting embodiment of an FTM can be found in PCT Application Number PCT/EP2019/074913, filed Sep. 17, 2019, which is hereby incorporated by reference in its entirety.

Referring to FIGS. 2-5, the filter 108 may comprise a container 132 and a dynamic membrane 114 having at least one liquid-permeable supporting element 144, such as a plurality of liquid-permeable supporting elements 144. The container 132 may be any object configured to hold a volume of liquid. The at least one liquid-permeable supporting element 144 may comprise a filtering mesh. For example, the at least one liquid-permeable supporting element 144 may comprise a filtering mesh comprising corrosion resistant metal or plastic such as stainless steel or polyester, or cloth and/or similar filtering mesh materials. A stainless steel filtering mesh is resistant to stretching during use and therefore has the benefit of prolonging the functional life of the at least one liquid-permeable supporting element 144. The at least one liquid-permeable supporting element 144 may comprise a filtering mesh that is inert to corrosion by the solid-liquid slurry 130 that may have an ORP of greater than 600 mV. The at least one liquid-permeable supporting element 144 may have any shape known in the art. For example, the at least one liquid-permeable supporting element 144 may have a circular or rectangular cross-section. The at least one liquid-permeable supporting element 144 may be a single stationary liquid-permeable supporting element 144. The at least one liquid-permeable supporting element 144 may comprise a plurality of liquid-permeable supporting elements 144. The at least one liquid permeable supporting element 144 comprises a first face 156 and a second face 158 opposite of the first face 156.

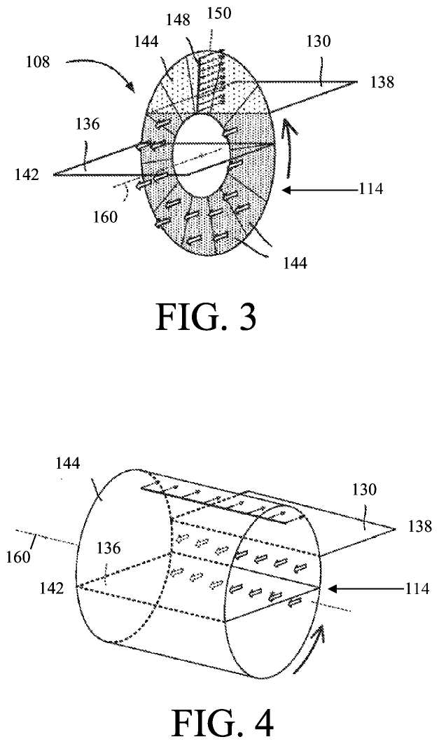

For example, the at least one liquid-permeable supporting element 144 of the dynamic membrane 114, such as a plurality of liquid-permeable supporting elements 144, may be in the form of a disc or a drum, such as the disc or drum liquid-permeable supporting element 144 of FIGS. 3-4. For example, the at least one liquid-permeable supporting element 144 of the dynamic membrane 114 may be the rotating disc or drum 144 of FIGS. 3-4. If the at least one liquid-permeable filtering element 144 is a disc or a drum 144, the disc or drum 144 may rotate to facilitate filtering. If the liquid-permeable filtering element is a disc or a drum 144, the first face 156 of the disc or drum 144 may be the external surface where the cake layer 140 forms, while the second face 158 is the internal surface of the disc or drum 144 and contained within the disc or drum 144. During rotation of the disc or drum 144, the pressure from the solid-liquid slurry 130 aids in filtration of the solid-liquid slurry, thereby producing a cake layer 140 on the first face 156 of the disc or drum 144. The filtrate 136 will collect within the disc or drum 144 and be transferred to external to the filter 108 via a transportation apparatus, such as a pump and a transfer pipe, channel, port, weir, and/or the like.

To avoid excessive stress and turbulence on the solids and flocs, the filter 108 may comprise a single, compact container 132, which may be only slightly larger than the dynamic membrane 114. Alternatively, the filter 108 may comprise a plurality of interconnected containers to contain the dynamic membrane 114 comprising the at least one liquid-permeable supporting element 144 and cake layer 140 and the corresponding components of the filter 108. In the filter 108, sedimentation is allowed such that the heavy agglomerates sink to the bottom, known as the slurry outlet. Aeration may be applied to the solid-liquid slurry 130 via at least one aerator 134 located at the bottom of the container 132 of the filter 108 such that the solids and floc remain suspended in the solid-liquid slurry 130 while waiting to be filtered, thus maintaining a homogenized solution of the solid-liquid slurry 130. The at least one aerator 134 may introduce gas bubbles into the solid-liquid slurry 130. The gas bubbles may be air, oxygen, nitrogen, and/or a combination thereof. The air and/or other gases (e.g. nitrogen) supplied by the at least one aerator 134 are sized at least at 1 normal cubic meter of gas per hour per cubic meter of the solid-liquid slurry 130 (Nm³/hr/m³) and up to 20 Nm³/hr/m³, such as 1-4 Nm³/hr/m³.

In the filter 108, there may be a small height difference between the side of the dynamic membrane 114 that includes the solid-liquid slurry 130 and the side of the dynamic membrane 114 that contains the filtrate 136. As seen in FIGS. 2-4, the level 138 of the solid-liquid slurry 130 in the filter 108 is provided and is higher than the level 142 of the filtrate 136 in the filter 108. The “filtrate” 136 is the solid-liquid slurry 130 after it has been filtered by the dynamic membrane 114, thereby removing the solids from the solid-liquid slurry 130. This height difference is typically up to 30 cm or 0.03 bar. This height difference may aid in maintaining the continuous filtration of the solid-liquid slurry 130 through the dynamic membrane 114. The solids will be continuously deposited on the first face 156 of the at least one liquid-permeable supporting element 144 of the dynamic membrane 114, creating the cake layer 140 of deposited solids that increases in thickness as more solids are deposited. This cake layer 140 will start at a thickness of less than 5 μm and will continuously grow, up to a thickness of 10,000 μm. Depending on the dewaterability of the cake layer 140, the cake layer 140 may even reach a thickness of up to 4 cm, or greater than 4 cm. This cake layer 140 can thicken on the first face 156 of the liquid-permeable supporting element 144, reaching 5-7% dry substance (DS) (i.e., 50,000 to 70,000 mg/L) from a starting concentration of 500 to 40,000 mg/L. Typical cake layer 140 concentrations range from 2-5% DS (dry solids, substance), which may be readily removed from the at least one liquid-permeable supporting element 144. The thicker the cake layer 140 is that forms on the first face 156 of the liquid-permeable supporting element 144, the lower the amount of TSS present in the filtrate 136. For example, a cake layer 140 of sufficient thickness on the first face 156 of the liquid-permeable supporting element 144 may produce a filtrate 136 having a TSS content of less than 10 mg/L. The filtrate 136 that leaves the filter 108 is suitable for polishing. As such, contrary to non-dynamic membrane filtration where deposition of solids on the membrane is avoided, the cake layer 140 formed on the at least one liquid-permeable supporting element 144 aids in the filtration of the solid-liquid slurry 130. For example, the formation of the cake layer 140 may reduce the permeation flux of the filter 108 while still promoting the filtration due to the cake layer 140 being liquid-permeable, thereby enabling the filtration process to achieve a filtrate 136 having a TSS content of less than 10 mg/L, such as less than 5 mg/L, such as less than 3 mg/L. The presence of the cake layer 140 is important for effective filtration by the filter 108 to achieve a filtrate 136 having a TSS content of less than 10 mg/L. This type of filtration may be referred to as dynamic.

The at least one liquid-permeable supporting element 144 may be sprayed with a liquid, such as a filtrate 136, to remove or aid in the removal of a cake layer 140 from the first face 156 of the at least one liquid-permeable supporting element 144 that forms from the deposition of solids onto the first face 156 of the at least one liquid-permeable supporting element 144.

For example, as shown in FIG. 2, the filter 108 may include at least one nozzle that is configured to shoot a jet or stream of fluid in the direction of the at least one liquid-permeable supporting element 144. For example, the filter 108 may comprise a first nozzle 148 that shoots a jet or stream 150 of fluid at the second face 158 of the liquid permeable supporting element 144, through the liquid permeable supporting element 144, and towards the first face 156 of the at least one liquid-permeable supporting element 144 to remove and/or aid in the removal of the cake layer 140 formed on the first face 156 of the at least one liquid-permeable supporting element 144. The jet or stream 150 of fluid may form a slip layer 146 between the at least one liquid-permeable supporting element 144 and cake layer 140. The filter 108 may comprise a second nozzle 152 that shoots a jet or stream 154 of fluid at the first face 156 of the liquid-permeable supporting element 144. The fluid provided by the first and/or second 148, 152 nozzle(s) may be any liquid known in the art. For example, said fluid provided by the first and/or second nozzle 148, 152 may be a liquid, such as a portion of the filtrate 136. Alternatively, said fluid provided by the first and/or second nozzle 148, 152 may be a gas.

In the case of a non-limiting rotating filter 108, said FTM may rotate at 0.3 to 2 rpm, or up to 4 rpm, such as to additionally aid in the deposition of the solids on the liquid-permeable supporting element 144 of the FTM. The cake layer 140 may be deposited, grown, and thickened in the time of one revolution of the FTM.

The dynamic membrane 114 comprising at least one liquid-permeable supporting element 144 and the cake layer 140 of the filter 108 removes the suspended solids from the solid-liquid slurry 130, thus producing a clear, liquid filtrate 136. The cake layer 140 remains on the first face 156 of the at least one liquid-permeable supporting element 144 until removed.

Alternative filtering methods provide excessive mixing, excessive retention times, and changes in temperature and pH that will negatively affect the filtrate 136 quality.

The at least one liquid-permeable supporting element 144 may have a specified pore size. For example, contrary to non-dynamic membrane filters which typically have a pore size less than 1 microns, the pore size of the at least one liquid-permeable supporting element 144 may be greater than 1 micron, or greater than 2 microns, or greater than 3 microns, or greater than 4 microns, or greater than 5 microns, or greater than 8 microns, or greater than 10 microns. The liquid-permeable supporting element may have a pore size in the range of from greater than 1 micron to 50 microns, or from greater than 1 micron to 40 microns, or from 2 microns to 40 microns, or from 2 microns to 30 microns, or from 2 microns to 25 microns, or from 2 microns to 20 microns, or from 5 microns to 20 microns.

The dynamic membrane 114 operates within the solid-liquid slurry 130, aided by aerators 134 which are used to maintain suspended solids in the solid-liquid slurry 130. The solid-liquid slurry 130 travels through the cake layer 140 and the liquid-permeable supporting element 144, and collecting on the opposite side of the liquid-permeable supporting element 144 as a filtrate 136 where it may then be transferred to external to the filter 108. If the at least one liquid-permeable supporting element 144 is in the shape of a disc or a drum, as shown in FIGS. 3-4, the filtrate 136 may be removed from the filter 108 via an opening 160 positioned coaxially to the disc or drum 144. The cake layer 140 that is deposited on the first face 156 of the liquid-permeable supporting element 144 of the dynamic membrane 114 may be removed by back-washing the second face 158 of the liquid-permeable supporting element 144 to generate a slip layer 146 between the cake layer 140 and the liquid-permeable supporting element 144. For example, water, such as the filtrate 136, may be applied from a first nozzle 148 to the second face 158 of the at least one liquid-permeable supporting element 144, such that the liquid goes through the at least one liquid-permeable supporting element 144 and towards the first face 156 of the at least one liquid-permeable supporting element 144 to form a slip layer 146 between the first face 156 of the at least one liquid-permeable supporting element 144 and the cake layer 140, thereby allowing the cake layer 140 to be more readily removed from the first face 156 of the liquid-permeable supporting element 144.

The cake layer 140 may then be removed from the first face 156 of the liquid-permeable supporting element 144 and returned into the solid-liquid slurry 130 where said cake layer 140 combines with a small amount of the solid-liquid slurry 130 to produce a sludge and will settle to the bottom in the sludge outlet. The filter 108 may operate at a TSS content in the solid-liquid slurry 130 of at least 500 mg/L, or at least 5,000 mg/L, or at least 10,000 mg/L. The filter 108 may operate at a TSS content in the solid-liquid slurry 130 of up to 50,000 mg/L, or up to 35,000 mg/L, or up to 20,000 mg/L. For example, the filter 108 may operate at a TSS content of the solid-liquid slurry 130 ranging from 10,000-20,000 mg/L.

For example, the FTM of PCT Application Number PCT/EP2019/074913 may be implemented at said TSS content levels. Referring to FIGS. 2-5, the filter 108 of the present invention may operate the same, or substantially the same, as the FTM of PCT/EP2019/074913. For example, the FTM may comprise a dynamic membrane 114 comprising at least one liquid-permeable supporting element 144 that includes a first face 156 and a second face 158 opposite of the first face 156. The cake layer 140 that forms from the filtering of the solids from the solid-liquid slurry 130 may form on the first face 156 of the at least one liquid-permeable supporting element 144. The solid-liquid slurry 130 may deliberately foul the at least one liquid-permeable supporting element 144, thereby forming the cake layer 140 on the first face 156 of the at least one liquid-permeable supporting element 144 and also a filtrate 136 which passes through the cake layer 140 and the at least one liquid-permeable supporting element 144. A liquid, such as the filtrate 136, may be sprayed at the at least one liquid-permeable supporting element 144 to remove and/or aid in the removal of the cake layer 140 from the first face 156 of the liquid-permeable supporting element 144. For example, a first nozzle 148 may spray a jet or stream 150 of fluid at the second face 158 of the at least one liquid-permeable supporting element 144. A second nozzle 152 may spray a jet or stream 154 of fluid at the first face 156 of the at least one liquid-permeable supporting element 144. For example, said fluid provided by the first and/or second nozzle 148, 152 may be a liquid, such as a portion of the filtrate 136. Alternatively, said fluid provided by the first and/or second nozzle 148, 152 may be a gas. A portion of the first face 156 of the at least one liquid-permeable supporting element 144 may be subject to the solid-liquid slurry 130 under pressure where the pressure across said portion of the first face 156 is greater than 0 and less than or equal to 6 kPa when the at least one liquid-permeable supporting element 144 is in a first position which is at least partially submerged in the solid-liquid slurry 130. In a second position, wherein the at least one liquid-permeable supporting element 144 is no longer submerged in the solid-liquid slurry 130, the first face 156 of the at least one liquid-permeable supporting element 144 is not subject to solid-liquid slurry 130 under pressure or is subject to the solid-liquid slurry 130 at a lower pressure than in the first position. The FTM may include at least one nozzle 148 that directs at least one jet or stream 150 of fluid at the second face 158 of the at least one liquid-permeable supporting element 144, through the at least one liquid-permeable supporting element 144, and towards the first face 156 of the at least one liquid-permeable supporting element 144 to remove and/or aid in the removal of the cake layer 140. A second nozzle 152 may spray a jet or stream 154 of fluid at the first face 156 of the at least one liquid-permeable supporting element 144. For example, said fluid provided by the first and/or second nozzle 148, 152 may be a liquid, such as a portion of the filtrate 136. Alternatively, said fluid provided by the first and/or second nozzle 148, 152 may be a gas. Software and physical performance enhancers may also be implemented to increase the efficiency of the filter 108. For example, the speed of rotation of the at least one liquid-permeable supporting element 144, intensity of aerator(s) 134, and the back-washing parameters are operated at lower intensity, compared to the biological treatment process of the FTM in PCT/EP2019/074913.

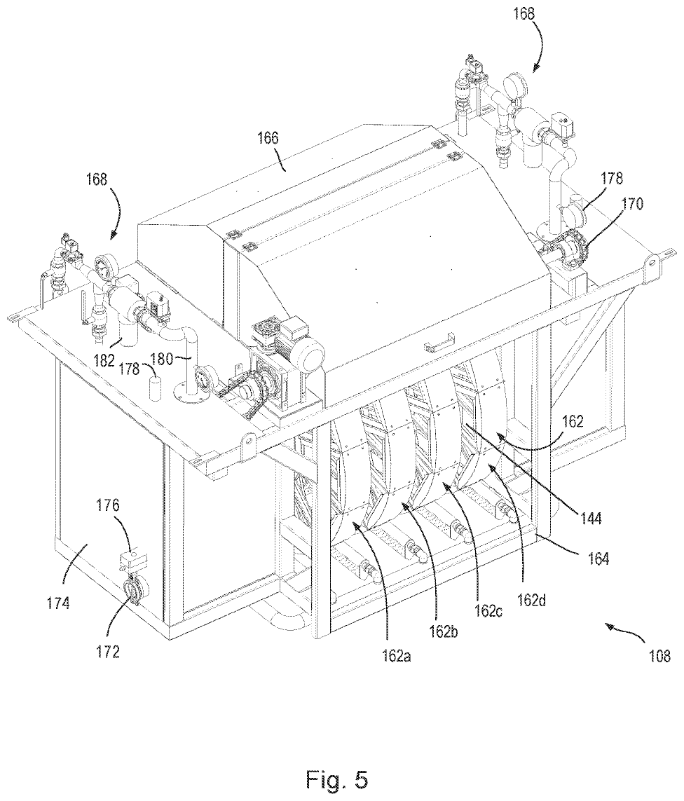

The filter 8 may be the filter 108 of FIG. 5, such as one of the various filters described in PCT/EP2019/074913. It is noted that the filter 108 is shown without a container 132, which has been removed for clarifying purposes. The filter 108 may comprise a disc structure 162. The disc structure 162 may comprise at least one disc 162a, such as a plurality of discs 162a-162d. Each disc 162a-162d comprises at least one liquid-permeable supporting element 144, such as a plurality of liquid-permeable supporting elements 144. The disc(s) 162a-162d take the form of a circular ring with an inside radius and an outside radius. The number of disc(s) 162a-162d in the disc structure 162 may be from 1 to 40, such as from 2 to 40, and an outer diameter from 0.5 m to 4 m. The filter 108 may be positioned rotatably inside a frame 164, such that the disc structure 162 may rotate along a center axis. The filter 108 may comprise a cover 166 over top of the disc structure 162. The rotation of the disc structure 162 may be enabled by the gearboxes and transmission shaft 170. The cover 166 may include hatches such that the cover can be opened to view the disc structure 164. The filter 108 may comprise at least one water supply system 168, such as at least two water supply systems 168. The water supply systems 168 may supply a fluid, such as a portion of the filtrate 136, to the nozzles 148, 152 (see FIG. 2) to be sprayed at the at least one liquid-permeable supporting element 144. The at least one water supply system 168 may comprise at least one pump 182 and at least one pipe 180 that transfers filtrate 136 from the filtrate tank 174 to the nozzles 148, 152 to be sprayed at the at least one liquid-permeable supporting element 144 to aid in the removal of the cake layer 140. Alternatively, said fluid provided by the first and/or second nozzle 148, 152 may be a gas. The filter 108 may comprise a filtrate outflow pipe 172 that the filtrate 136 travels through to exit the filter 108 and is connected upstream to a filtrate tank 174 which contains the filtrate 136 before it is removed from the filter 108. At least one motorized valve 176 may be provided to open and close the filtrate outflow pipe 172. The filter 108 may comprise at least one turbidity sensor 178 to verify the turbidity of the filtrate 136 containing in the filtrate tank 174. It is noted that each component of the water supply system 168 and the filtrate tank 174 may be provided on both sides of the filter 108, such that two water supply systems 168 are provided, one on each side of the filter 108, such that filtrate 130 may be removed and/or cycled through the water supply system(s) 168 on both sides of the filter 108.

The at least one liquid-permeable supporting element 144 of the filter 108 may have an optimized pore size, such as a pore size in the range of 2 to 40 μm. The filter 108 may consume from 0.02 to 0.14 kilowatt hours per meter cubed of filtrate 136 processed (kWh/m³), while known filtration devices and processes operate at 0.15 to 0.25 kWh/m³.

As previously stated, the cake layer 140, formed from the solids that was suspended in the solid-liquid slurry 130 prior to filtering, may be removed from the first face 156 of the at least one liquid-permeable supporting element 144 and reintroduced into the solid-liquid slurry 130. When reintroduced into the solid-liquid slurry 130, the cake layer 140 will combine with a small amount of the solid-liquid slurry 130 to form a sludge and will sink to bottom of the container 132 to the sludge outlet. For example, back-washing of the at least one liquid-permeable supporting element 144 may aid in the removal of the cake layer 140, by applying a jet or stream 150 of a fluid to the second face 158 of the at least one liquid-permeable supporting element 144 from a nozzle 148, thereby penetrating the at least one liquid-permeable supporting element 144 and generating a slip layer 146 between the cake layer 140 and the first face 156 of the at least one liquid-permeable supporting element 144. Alternatively, the nozzle 148 may apply a jet or stream 150 of gas to the second face 158 of the at least one liquid-permeable supporting element 144. Once the cake layer 140 is separated from the first face 156 of the at least one liquid-permeable supporting element 144, gravity reintroduces the cake layer 140 into the solid-liquid slurry 130 and the cake layer 140 falls to the sludge outlet. As the cake layer 140 falls through the solid-liquid slurry 130, the cake layer 140 is combined with a small amount of the solid-liquid slurry 130, thereby producing a sludge. For example, by the time the cake layer 140, that has been removed from the first face 156 of the at least one liquid-permeable supporting element 144, reaches the sludge outlet, the cake 140 will have been combined with enough solid-liquid slurry 130 to produce a sludge. The sludge may be removed from the sludge outlet using a transportation apparatus. For example, the sludge may be removed from the sludge outlet by pumping the sludge with a pump through pipe(s) to a waste to energy system. Alternatively, a height difference between the level 138 of the solid-liquid slurry 130 in the container 132 of the filter 108 and the level of the sludge in the waste to energy system may cause gravity to transport the sludge from the sludge outlet to external to the filter 108, such as to the waste to energy system. The filtrate 136 may also be removed from the filter 108 with a transportation apparatus. The transportation apparatus that transports the filtrate 136 out of the filter 108 may include a pump that pumps the filtrate 136 through pipe(s) to external to the filter 108.

The cake layer 140 that is removed from the first face 156 of the at least one liquid-permeable supporting element 144 falls into the solid-liquid slurry 130, where said cake layer 140 combines with a small amount of solid-liquid slurry 130 to produce a sludge, and then said sludge continues to sink until it is accumulated in the sludge outlet. The sludge may be suitable as a source of fuel for an energy process. The concentration of TSS in the solid-liquid slurry 130 may be between 2% DS and 5% DS (20,000 to 50,000 mg/L) and may be a concentration suitable for a waste to energy process and/or plant. As used herein, “waste to energy” refers to a process or a system that takes a contaminated liquid and processes said liquid to produce a substance that can be used as a source of energy. The sludge removed from the sludge outlet of the filter 108 may have a calorific value in the range of 18 and 25 MJ/kg of dry substance and which is above the calorific value of the known activated sludge processes, which typically ranges from 12-15 MJ/kg of dry substance. Thus, the present process may generate more biogas from an enriched carbon source than known processes in the art.

The sludge, having a TSS content of from 10,000-50,000 mg/L, is extracted from the sludge outlet at the bottom of the container 132 of the filter 108. The hydraulic retention time of the solid-liquid slurry 130, in the container 132 of the filter 108, may be from 5 minutes to 30 minutes. This retention time of the solid-liquid slurry 130 in the container 132 of the filter 108 is such so as to avoid floc deterioration or the onset of any biological reactions from bacteria that enters the system. Air mixing from the at least one aerator 134 may be used to aid in the avoidance of foaming. The sludge may have a TSS content of at least 10,000 mg/L, or at least 12,000 mg/L, or at least 15,000 mg/L. The sludge may have a TSS content of up to 70,000 mg/L, or up to 60,000 mg/L, or up to 50,000 mg/L, or up to 25,000 mg/L. The TSS content of the sludge and/or the solid-liquid slurry 130 may be continuously monitored so that the rate of filtering may be controlled to maintain a TSS content in the sludge, such as to maintain a TSS content in the sludge of at least 10,000 mg/L.

Referring back to FIG. 1, after the solid-liquid slurry 130 has been filtered by the filter 8 to produce a filtrate 136, the filtrate 136 may be transported to external from the filter 8. The filtrate 136 may be transported by a second transfer stream 112 to external from the filter 8. For example, the second transfer stream 112 may be in fluid communication with the filter 8 and configured to transport the filtrate 136 to external from the filter 8. In some non-limiting embodiments, the second transfer stream 112 may include a pump and a transfer pipe, channel, port, weir, and/or the like that aid in transporting the filtrate 136 from the filter 8 to external from the filter 8. In some non-limiting embodiments, a height difference between the filtrate 136 in the filter 8 and the filtrate 136 located external from the filter 8 may aid in transporting the filtrate 136 from the filter 8 to external from the filter 8.

In some non-limiting embodiments, at least a portion of the solid-liquid slurry 130 contained within the filter 8 may be transported back to the bioreactor 104 in a first recycle stream 110. The first recycle stream 110 may be in fluid communication with the bioreactor 104 and a filter 8, and configured to transport at least a portion of the solid-liquid slurry 130 from the filter 8 back to the bioreactor 104. In some non-limiting embodiments, the first recycle stream 110 may include a pump and a transfer pipe, channel, port, weir, and/or the like that aid in transporting the solid-liquid slurry 130 from the filter 8 back to the bioreactor 104. In some non-limiting embodiments, a height difference between the solid-liquid slurry 130 in the filter 8 and the solid-liquid slurry 130 in the bioreactor 104 may aid in transporting the solid-liquid slurry 130 from the filter 8 back to the bioreactor 104.

In some non-limiting embodiments, a chemical additive may be added to the system 100. The chemical additive may comprise ferric chloride, aluminum sulfate, Detafloc, polyaluminum chloride such as polydiallyldimethylammonium chloride, polyacrylamide, polyethyleneimine, MPE 50, Praestol 187, Chitosan, Superfloc C-595, Superfloc C-592, Superfloc C-569, Superfloc C-581, Accepta 4222, Accepta 4223, Lupasol P, Lupasol SK, C8030, Zetag 8165, or combinations thereof. The chemical additive may include a polymer. The chemical additive may include any polymer known in the art. In some non-limiting embodiments, the polymer of the chemical additive comprises a cationic polymer. As used herein, a “cationic” polymer is a polymer that possesses positive charge(s) in the polymer backbone and/or a pendant side group. In some non-limiting embodiments the polymer of the chemical additive may comprise a high molecular weight cationic polymer. As used herein, a “high molecular weight” polymer is a polymer having a weight average molecular weight of at least 20,000 g/mol. The polymer of the chemical additive may have a molecular weight of greater than 5,000 g/mol, or greater than 10,000 g/mol, or greater than 20,000 g/mol, or greater than 50,000 g/mol, or greater than 100,000 g/mol, or greater than 150,000 g/mol, or greater than 200,000 g/mol, or greater than 250,000 g/mol, or greater than 300,000 g/mol. Weight average molecular weight can be measured using gel permeation chromatography, light-scattering measurements, and/or viscosity measurements. In some non-limiting embodiments, the polymer may comprise a cationic polymer, including but not limited to, polyaluminum chloride such as polydiallyldimethylammonium chloride, polyacrylamide, polyethyleneimine, or combinations thereof. For example, the polymer may comprise polydiallyldimethylammonium chloride. The polymer of the chemical additive may comprise MPE-50 (Nalco Company (Naperville, IL)), PRAESTOL 187 (Solenis (Wilmington, DE)), Chitosan (Tidal Vision (Bellingham, WA)), Superfloc C-595, Superfloc C-592, Superfloc C-569, Superfloc C-581 (Kemira (Helsinki, Finland)), Accepta 4222, Accepta 4223 (Accepta (Moreton, United Kingdom)), Lupasol P, Lupasol SK (BASF (Ludwigshafen, Germany)), C8030 (Yixing Bluwat Chemicals (Yixing, China)), Zetag 8165 (BASF (Ludwigshafen, Germany)), and/or the like. The chemical additive may be diluted prior to adding into the system 100. For example, the chemical additive may be diluted with water prior to adding into the system 100. The chemical additive may be added to the system 100 using any known means in the art. For example, the chemical additive may be added to the system 100 manually, e.g., by hand. As another example, a closed loop system that may include a pump may be used to add the chemical additive into the system 100. The chemical additive may be added to the solid-liquid slurry 130 of the system 100 at the inlet zone 102, the bioreactor 104, the first transfer stream 106, the filter 8, and/or the first recycle stream 110.

The mechanism for adding the chemical additive may be configured to add a specific amount of chemical additive to the solid-liquid separation system 100. For example, the mechanism for adding the chemical additive may be configured to add less than 500 mg/L, or less than 250 mg/L, or less than 100 mg/L, or less than 75 mg/L, or less than 50 mg/L, or less than 25 mg/L, or less than 12.5 mg/L, or less than 6 mg/L, or less than 5 mg/L of chemical additive to the system 100. The solid-liquid slurry 130 flow and its total suspended solids content can drastically fluctuate based on environmental and community conditions. The amount of chemical additive added to the solid-liquid separation system 100 may be varied between dosages in order to account for the changes in solid-liquid slurry conditions. For example, a first dose of chemical additive into the solid-liquid separation system 100 may be of a first concentration based on conditions of the solid-liquid slurry 130 at a first time and a second dose of chemical additive may be of a second concertation based on conditions of the solid-liquid slurry 130 at a second time. The concentration of chemical additive dosed into the solid-liquid separation system 100 may be changed between dosages in order to achieve a certain average/peak flux, total suspended solids content, and/or turbidity goal. Additionally, for a rotating filter 8, such as filter 108 of FIGS. 2-5, the rotational speed of the filter 8 may also be varied alternatively or in addition to varying the concentration of the chemical additive dosed between dosages. In some non-limiting embodiments, a flow rate and effluent turbidity meter may be used to measure the flow rate and/or turbidity of the solid-liquid slurry 130 and determine the dosing amount of chemical additive and/or the rotation speed of the filter 8.

The chemical additive may increase both the peak flux and the average flux of the filter 8. As used herein, flux is measured using a flow meter and dividing the measured flow rate by the surface area of the dynamic membrane. For example, the addition of the chemical additive may increase the average flux across the dynamic membrane 14 to at least 500 L/m² h, or to at least 750 L/m² h, to at least 1,000 L/m² h, or at least 1,250 L/m² h, or at least 1,500 L/m² h, or at least 1,700 L/m² h. For example, the addition of the chemical additive may increase the average flux across the dynamic membrane 14 by at least 25%, or at least 40%, or at least 50%, or at least 60%, or at least 70%, or at least 80%, or at least 90%, or at least 100%, compared to the average flux across the dynamic membrane 14 prior to the addition of the chemical additive. When the chemical additive increases the flux, the kwh/m³ wastewater that is treated decreases. The chemical additive may also decrease the TSS content that is present in the final filtrate 136. For example, the addition of the chemical additive may decrease the TSS content in the final filtrate 136 to less than 20 mg/L, or less than 15 mg/L, or less than 10 mg/L, or less than 5 mg/L, or less than 4 mg/L, or less than 3 mg/L, or less than 2.5 mg/L, or less than 2 mg/L. For example, the addition of the chemical additive may decrease the TSS content in the final filtrate 136 by at least 25%, or by at least 30%, or by at least 35%, or by at least 40%, or by at least 45%, or by at least 50%, compared to the TSS content in the final filtrate 136 prior to the addition of the chemical additive. TSS can be measured according to standard method 2540 B using a filter medium of less than 2 microns and drying for 103-105° C. four 1 hour.

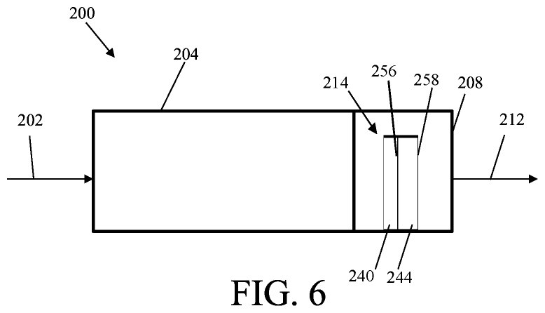

Referring to FIG. 6, a solid-liquid separation system 200 for producing a filtrate from a solid-liquid slurry is provided. The solid-liquid slurry enters the system from a source the solid-liquid slurry to an inlet zone 202. The inlet zone 202 may be the same as the inlet zone 102 previously described.

After the solid-liquid slurry leaves the inlet zone 202, the solid-liquid slurry may enter a bioreactor 204. The bioreactor 204 may be the same as the bioreactor 104 previously described. For example, the bioreactor 204 may include various biological processes, such as an aerobic zone, an anoxic zone, and/or an anaerobic zone.

In some non-limiting embodiments, a filter 208 may be included in the same tank as the bioreactor 204. For example, after the solid-liquid slurry has undergone the biological processes of the bioreactor 204, the solid-liquid slurry may then enter the filter 208 without exiting the tank of the bioreactor 204.

The filter 208 may be configured to filter suspended solids from the solid-liquid slurry to produce a filtrate and cake. The filter 208 may be any filter known in the art. For example, the filter 208 may be the same as the filter 8 previously described, such as the filter 108. The filter 208 comprises a dynamic membrane 214 comprising a liquid-permeable supporting element 244 comprising a first face 256 and a second face 258 opposite the first face 256, and may include a cake layer 240 of deposited solids on the first face 256 of the liquid-permeable supporting element 244. The dynamic membrane 214 comprising the liquid permeable supporting element 244 and the cake layer 240 may be the same as the dynamic membrane 14 comprising the liquid-permeable supporting element 44 and the cake layer 40 previously described, such as the dynamic membrane 114 comprising the at least one liquid-permeable supporting element 144 and the cake layer 140 previously described.

After the solid-liquid slurry has been filtered by the filter 208 to produce a filtrate, the filtrate may be transported to external from the filter 208. The filtrate may be transported by a first transfer stream 212 to external from the filter 208. The first transfer stream 212 may be the same as the second transfer stream 112 previously described.

In some non-limiting embodiments, a chemical additive may be added to the system 200. The chemical additive may comprise ferric chloride, aluminum sulfate, Detafloc, polyaluminum chloride such as polydiallyldimethylammonium chloride, polyacrylamide, polyethyleneimine, MPE 50, Praestol 187, Chitosan, Superfloc C-595, Superfloc C-592, Superfloc C-569, Superfloc C-581, Accepta 4222, Accepta 4223, Lupasol P, Lupasol SK, C8030, Zetag 8165, or combinations thereof. The chemical additive may include a polymer. The chemical additive may include any polymer known in the art. In some non-limiting embodiments, the polymer of the chemical additive comprises a cationic polymer. In some non-limiting embodiments the polymer of the chemical additive may comprise a high molecular weight cationic polymer. As used herein, a “high molecular weight” polymer is a polymer having a weight average molecular weight of at least 20,000 g/mol. The polymer of the chemical additive may have a molecular weight of greater than 5,000 g/mol, or greater than 10,000 g/mol, or greater than 20,000 g/mol, or greater than 50,000 g/mol, or greater than 100,000 g/mol, or greater than 150,000 g/mol, or greater than 200,000 g/mol, or greater than 250,000 g/mol, or greater than 300,000 g/mol. Weight average molecular weight can be measured using gel permeation chromatography, light-scattering measurements, and/or viscosity measurements. In some non-limiting embodiments, the polymer may comprise a cationic polymer, including but not limited to, polyaluminum chloride such polydiallyldimethylammonium chloride, polyacrylamide, polyethyleneimine, or combinations thereof. For example, the polymer may comprise polydiallyldimethylammonium chloride. The polymer of the chemical additive may comprise MPE-50 (Nalco Company (Naperville, IL)), PRAESTOL 187 (Solenis (Wilmington, DE)), Chitosan (Tidal Vision (Bellingham, WA)), Superfloc C-595, Superfloc C-592, Superfloc C-569, Superfloc C-581 (Kemira (Helsinki, Finland)), Accepta 4222, Accepta 4223 (Accepta (Moreton, United Kingdom)), Lupasol P, Lupasol SK (BASF (Ludwigshafen, Germany)), C8030 (Yixing Bluwat Chemicals (Yixing, China)), Zetag 8165 (BASF (Ludwigshafen, Germany)), and/or the like. The chemical additive may be diluted prior to adding into the system 200. For example, the chemical additive may be diluted with water prior to adding into the system 200. The chemical additive may be added to the system 200 using any known means in the art. For example, the chemical additive may be added to the system 200 manually, e.g., by hand. As another example, a closed loop system that may include a pump may be used to add the chemical additive into the system 200. The chemical additive may be added to the solid-liquid slurry of the system 200 at the inlet zone 202, the bioreactor 204, and/or the filter 208.

The mechanism for adding the chemical additive may be configured to add a specific amount of chemical additive to the solid-liquid separation system 200. For example, the mechanism for adding the chemical additive may be configured to add less than 500 mg/L, or less than 250 mg/L, or less than 100 mg/L, or less than 75 mg/L, or less than 50 mg/L, or less than 25 mg/L, or less than 12.5 mg/L, or less than 6 mg/L, or less than 5 mg/L of chemical additive to the system 200. The solid-liquid slurry flow and its total suspended solids content can drastically fluctuate based on environmental and community conditions. The amount of chemical additive added to the solid-liquid separation system 200 may be varied between dosages in order to account for the changes in solid-liquid slurry conditions. For example, a first dose of chemical additive into the solid-liquid separation system 200 may be of a first concentration based on conditions of the solid-liquid slurry at a first time and a second dose of chemical additive may be of a second concertation based on conditions of the solid-liquid slurry at a second time. The concentration of chemical additive dosed into the solid-liquid separation system 200 may be changed between dosages in order to achieve a certain average/peak flux, total suspended solids content, and/or turbidity goal. Additionally, for a rotating filter 208, such as filter 108 of FIGS. 2-5, the rotational speed of the filter 208 may also be varied alternatively or in addition to varying the concentration of the chemical additive dosed between dosages. In some non-limiting embodiments, a flow rate and effluent turbidity meter may be used to measure the flow rate and/or turbidity of the solid-liquid slurry and determine the dosing amount of chemical additive and/or the rotation speed of the filter 208.

The chemical additive may increase both the peak flux and the average flux of the filter 208. For example, the addition of the chemical additive may increase the average flux across the dynamic membrane 214 to at least 500 L/m² h, or to at least 750 L/m² h, to at least 1,000 L/m² h, or at least 1,250 L/m² h, or at least 1,500 L/m² h, or at least 1,700 L/m² h. For example, the addition of the chemical additive may increase the average flux across the dynamic membrane 214 by at least 25%, or at least 40%, or at least 50%, or at least 60%, or at least 70%, or at least 80%, or at least 90%, or at least 100%, compared to the average flux across the dynamic membrane 214 prior to the addition of the chemical additive. When the chemical additive increases the flux, the kwh/m³ wastewater that is treated decreases. The chemical additive may also decrease the TSS content that is present in the final filtrate. For example, the addition of the chemical additive may decrease the TSS content in the final filtrate to less than 20 mg/L, or less than 15 mg/L, or less than 10 mg/L, or less than 5 mg/L, or less than 4 mg/L, or less than 3 mg/L, or less than 2.5 mg/L, or less than 2 mg/L. For example, the addition of the chemical additive may decrease the TSS content in the final filtrate by at least 25%, or by at least 30%, or by at least 35%, or by at least 40%, or by at least 45%, or by at least 50%, compared to the TSS content in the final filtrate prior to the addition of the chemical additive.

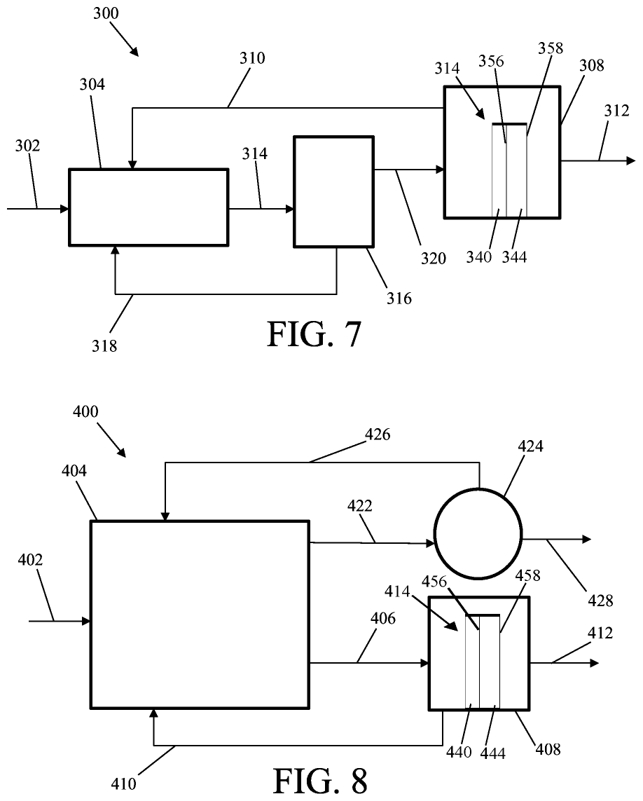

Referring to FIG. 7, a solid-liquid separation system 300 for producing a filtrate from a solid-liquid slurry is provided. The solid-liquid slurry enters the system from a source of the solid-liquid slurry to an inlet zone 302. The inlet zone 302 may be the same as the inlet zone 102 previously described.

After the solid-liquid slurry leaves the inlet zone 302, the solid-liquid slurry may enter a bioreactor 304. The bioreactor 304 may be the same as the bioreactor 104 previously described. For example, the bioreactor 304 may include various biological processes, such as an aerobic zone, an anoxic zone, and/or an anaerobic zone.

After the solid-liquid slurry is subjected to the biological processes of the bioreactor 304, the solid-liquid slurry may be transported from the bioreactor 304 in a first transfer stream 314. The first transfer stream 314 may be in fluid communication with the bioreactor 304 and a density based solids water separation unit 316, and configured to transport the solid-liquid slurry from the bioreactor 304 to the density based solids water separation unit 316. In some non-limiting embodiments, the first transfer stream 314 may include a pump and a transfer pipe, channel, port, weir, and/or the like that aid in transporting the solid-liquid slurry from the bioreactor 304 to the density based solids water separation unit 316. In some non-limiting embodiments, a height difference between the solid-liquid slurry in the bioreactor 304 and the solid-liquid slurry in the density based solids water separation unit 316 may aid in transporting the solid-liquid slurry from the bioreactor 304 to the density based solids water separation unit 316.

The first transfer stream 314 transports the solid-liquid slurry to a density based solids water separation unit 316. The density based solids water separation unit 316 may be configured to separate solids based on the density of the solids. For example, if a first portion of the solids have a high density, the first portion of the solids may sink to the bottom of the density based solids water separation unit 316. If a second portion of the solids have a low density, the second portion of the solids may float in the density based solids water separation unit 316. The “high” and “low” density may be based on the density of water, such as the solid-liquid slurry contained in the density based solids water separation unit 316. For example, if the first portion of the solids has a higher density than the solid-liquid slurry in the density based solids water separation unit 316, the first portion of the solids will sink to the bottom of the density based solids water separation unit 316. If the second portion of the solids has a lower density than the solid-liquid slurry in the density based solids water separation unit 316, the second portion of the solids will float in the solid-liquid slurry in the density based solids water separation unit 316.

In some non-limiting embodiments, at least a portion of the solid-liquid slurry contained within the density based solids water separation unit 316 may be transported back to the bioreactor 304 in a first recycle stream 318. The portion of the solid-liquid slurry that is transported back to the bioreactor 304 in the first recycle stream 318 may include the first portion of the solids that have a high density and sink to the bottom of the density based solids water separation unit 316. The first recycle stream 318 may be in fluid communication with the bioreactor 304 and a density based solids water separation unit 316, and configured to transport at least a portion of the solid-liquid slurry from the density based solids water separation unit 316 back to the bioreactor 304. In some non-limiting embodiments, the first recycle stream 318 may include a pump and a transfer pipe, channel, port, weir, and/or the like that aid in transporting the wastewater from the density based solids water separation unit 316 back to the bioreactor 304. In some non-limiting embodiments, a height difference between the solid-liquid slurry in the density based solids water separation unit 316 and the solid-liquid slurry in the bioreactor 304 may aid in transporting the solid-liquid slurry from the density based solids water separation unit 316 back to the bioreactor 304.

After the density based solids water separation unit 316, at least a portion of the solid-liquid slurry may be transported from the density based solids water separation unit 316 in a second transfer stream 320. The at least a portion of the solid-liquid slurry that is transported from the density based solids water separation unit 316 in the second transfer stream 320 may include the second portion of the solids with a low density and that floats in the solid-liquid slurry in the density based solids water separation unit 316. The second transfer stream 320 may be in fluid communication with the density based solids water separation unit 316 and a filter 308, and configured to transport the solid-liquid slurry from the density based solids water separation unit 316 to the filter 308. In some non-limiting embodiments, the second transfer stream 320 may include a pump and a transfer pipe, channel, port, weir, and/or the like that aid in transporting the solid-liquid slurry from the density based solids water separation unit 316 to the filter 308. In some non-limiting embodiments, a height difference between the solid-liquid slurry in the density based solids water separation unit 316 and the solid-liquid slurry in the filter 308 may aid in transporting the solid-liquid slurry from the density based solids water separation unit 316 to the filter 308.

The second transfer stream 320 transports the solid-liquid slurry to a filter 308. The filter 308 may be configured to filter suspended solids from the solid-liquid slurry to produce a filtrate and cake. The filter 308 may be any filter known in the art. For example, the filter 308 may be the same as the filter 8 previously described, such as the filter 108. The filter 308 comprises a dynamic membrane 314 comprising a liquid-permeable supporting element 344 comprising a first face 356 and a second face 358 opposite the first face 356, and may include a cake layer 340 of deposited solids on the first face 356 of the liquid-permeable supporting element 344. The dynamic membrane 314 comprising the liquid permeable supporting element 344 and the cake layer 340 may be the same as the dynamic membrane 14 comprising the liquid-permeable supporting element 44 and the cake layer 40 previously described, such as the dynamic membrane 114 comprising the at least one liquid-permeable supporting element 144 and the cake layer 140 previously described.

After the solid-liquid slurry has been filtered by the filter 308 to produce a filtrate, the filtrate may be transported to external from the filter 308. The filtrate may be transported by a third transfer stream 312 to external from the filter 308. The third transfer stream 312 may be the same as the second transfer stream 112 previously described.

In some non-limiting embodiments, at least a portion of the solid-liquid slurry contained within the filter 308 may be transported back to the bioreactor 304 in a second recycle stream 310. The second recycle stream 310 may be the same as the first recycle stream 110.

In some non-limiting embodiments, a chemical additive may be added to the system 300. The chemical additive may comprise ferric chloride, aluminum sulfate, Detafloc, polyaluminum chloride such as polydiallyldimethylammonium chloride, polyacrylamide, polyethyleneimine, MPE 50, Praestol 187, Chitosan, Superfloc C-595, Superfloc C-592, Superfloc C-569, Superfloc C-581, Accepta 4222, Accepta 4223, Lupasol P, Lupasol SK, C8030, Zetag 8165, or combinations thereof. The chemical additive may include a polymer. The chemical additive may include any polymer known in the art. In some non-limiting embodiments, the polymer of the chemical additive comprises a cationic polymer. In some non-limiting embodiments the polymer of the chemical additive may comprise a high molecular weight cationic polymer. As used herein, a “high molecular weight” polymer is a polymer having a weight average molecular weight of at least 20,000 g/mol. The polymer of the chemical additive may have a molecular weight of greater than 5,000 g/mol, or greater than 10,000 g/mol, or greater than 20,000 g/mol, or greater than 50,000 g/mol, or greater than 100,000 g/mol, or greater than 150,000 g/mol, or greater than 200,000 g/mol, or greater than 250,000 g/mol, or greater than 300,000 g/mol. Weight average molecular weight can be measured using gel permeation chromatography, light-scattering measurements, and/or viscosity measurements. In some non-limiting embodiments, the polymer may comprise a cationic polymer, including but not limited to, polyaluminum chloride such as polydiallyldimethylammonium chloride, polyacrylamide, polyethyleneimine, or combinations thereof. For example, the polymer may comprise polydiallyldimethylammonium chloride. The polymer of the chemical additive may comprise MPE-50 (Nalco Company (Naperville, IL)), PRAESTOL 187 (Solenis (Wilmington, DE)), Chitosan (Tidal Vision (Bellingham, WA)), Superfloc C-595, Superfloc C-592, Superfloc C-569, Superfloc C-581 (Kemira (Helsinki, Finland)), Accepta 4222, Accepta 4223 (Accepta (Moreton, United Kingdom)), Lupasol P, Lupasol SK (BASF (Ludwigshafen, Germany)), C8030 (Yixing Bluwat Chemicals (Yixing, China)), Zetag 8165 (BASF (Ludwigshafen, Germany)), and/or the like. The chemical additive may be diluted prior to adding into the system 300. For example, the chemical additive may be diluted with water prior to adding into the system 300. The chemical additive may be added to the system 300 using any known means in the art. For example, the chemical additive may be added to the system 300 manually, e.g., by hand. As another example, a closed loop system that may include a pump may be used to add the chemical additive into the system 300. The chemical additive may be added to the solid-liquid slurry of the system 300 at the inlet zone 302, the bioreactor 304, the first transfer stream 314, the second transfer stream 320, the first recycle stream 318, the second recycle stream 310, and/or the filter 308.

The mechanism for adding the chemical additive may be configured to add a specific amount of chemical additive to the solid-liquid separation system 300. For example, the mechanism for adding the chemical additive may be configured to add less than 500 mg/L, or less than 250 mg/L, or less than 100 mg/L, or less than 75 mg/L, or less than 50 mg/L, or less than 25 mg/L, or less than 12.5 mg/L, or less than 6 mg/L, or less than 5 mg/L. The solid-liquid slurry flow and its total suspended solids content can drastically fluctuate based on environmental and community conditions. The amount of chemical additive added to the solid-liquid separation system 300 may be varied between dosages in order to account for the changes in solid-liquid slurry conditions. For example, a first dose of chemical additive into the solid-liquid separation system 300 may be of a first concentration based on conditions of the solid-liquid slurry at a first time and a second dose of chemical additive may be of a second concertation based on conditions of the solid-liquid slurry at a second time. The concentration of chemical additive dosed into the solid-liquid separation system 300 may be changed between dosages in order to achieve a certain average/peak flux, total suspended solids content, and/or turbidity goal. Additionally, for a rotating filter 308, such as filter 108 of FIGS. 2-5, the rotational speed of the filter 308 may also be varied alternatively or in addition to varying the concentration of the chemical additive dosed between dosages. In some non-limiting embodiments, a flow rate and effluent turbidity meter may be used to measure the flow rate and/or turbidity of the solid-liquid slurry and determine the dosing amount of chemical additive and/or the rotation speed of the filter 308.

The chemical additive may increase both the peak flux and the average flux of the filter 308. For example, the addition of the chemical additive may increase the average flux across the dynamic membrane 314 to at least 500 L/m² h, or to at least 750 L/m² h, to at least 1,000 L/m² h, or at least 1,250 L/m² h, or at least 1,500 L/m² h, or at least 1,700 L/m² h. For example, the addition of the chemical additive may increase the average flux across the dynamic membrane 314 by at least 25%, or at least 40%, or at least 50%, or at least 60%, or at least 70%, or at least 80%, or at least 90%, or at least 100%, compared to the average flux across the dynamic membrane 314 prior to the addition of the chemical additive. When the chemical additive increases the flux, the kwh/m³ wastewater that is treated decreases. The chemical additive may also decrease the TSS content that is present in the final filtrate. For example, the addition of the chemical additive may decrease the TSS content in the final filtrate to less than 20 mg/L, or less than 15 mg/L, or less than 10 mg/L, or less than 5 mg/L, or less than 4 mg/L, or less than 3 mg/L, or less than 2.5 mg/L, or less than 2 mg/L. For example, the addition of the chemical additive may decrease the TSS content in the final filtrate by at least 25%, or by at least 30%, or by at least 35%, or by at least 40%, or by at least 45%, or by at least 50%, compared to the TSS content in the final filtrate prior to the addition of the chemical additive.

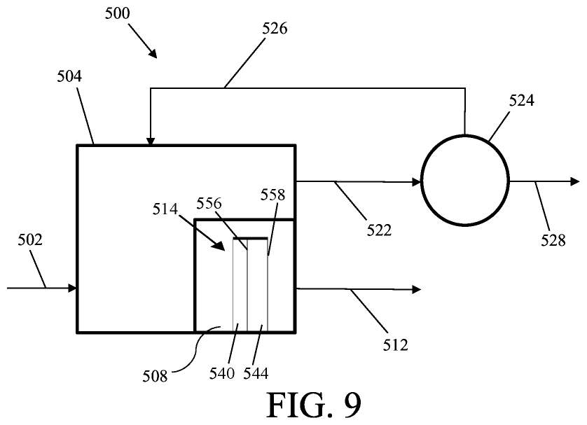

Referring to FIG. 8, a solid-liquid separation system 400 for producing a filtrate from a solid-liquid slurry is provided. The solid-liquid slurry enters the system from a source of the solid-liquid slurry to an inlet zone 402. The inlet zone 402 may be the same as the inlet zone 102 previously described.

After the solid-liquid slurry leaves the inlet zone 402, the wastewater may enter a bioreactor 404. The bioreactor 404 may be the same as the bioreactor 104 previously described. For example, the bioreactor 404 may include various biological processes, such as an aerobic zone, an anoxic zone, and/or an anaerobic zone.

After the solid-liquid slurry is subjected to the biological processes of the bioreactor 404, at least a portion of the solid-liquid slurry may be transported from the bioreactor 404 in a first transfer stream 406. The first transfer stream 406 may transport at least a portion of the solid-liquid slurry from the bioreactor 404 to a filter 408. The first transfer stream 406 may be the same as the first transfer stream 106 previously described.

In some non-limiting embodiments, after the solid-liquid slurry is subjected to the biological processes of the bioreactor 404, at least a portion of the solid-liquid slurry may also be transported from the bioreactor 404 in a second transfer stream 422. The second transfer stream 422 may be in fluid communication with the bioreactor 404 and a solid water separation unit 424, and configured to transport at least a portion of the solid-liquid slurry from the bioreactor 404 to the solid water separation unit 424. In some non-limiting embodiments, the second transfer stream 422 may include a pump and a transfer pipe, channel, port, weir, and/or the like that aid in transporting at least a portion of the solid-liquid slurry from the bioreactor 404 to the solid water separation unit 424. In some non-limiting embodiments, a height difference between the solid-liquid slurry in the bioreactor 404 and the solid-liquid slurry in the solid water separation unit 424 may aid in transporting at least a portion of the solid-liquid slurry from the bioreactor 404 to the solid water separation unit 424.

The first transfer stream 406 transports at least a portion of the solid-liquid slurry to a filter 408. The filter 408 may be configured to filter suspended solids from the solid-liquid slurry to produce a filtrate and cake. The filter 408 may be any filter known in the art. For example, the filter 408 may be the same as the filter 8 previously described, such as the filter 108. The filter 408 comprises a dynamic membrane 414 comprising a liquid-permeable supporting element 444 comprising a first face 456 and a second face 458 opposite the first face 456, and may comprise a cake layer 440 of deposited solids over at least a portion of the first face 456 of the liquid-permeable supporting element 444. The dynamic membrane 414 comprising the liquid permeable supporting element 444 and the cake layer 440 may be the same as the dynamic membrane 14 comprising the liquid-permeable supporting element 44 and the cake layer 40 previously described, such as the dynamic membrane 114 comprising the at least one liquid-permeable supporting element 144 and the cake layer 140 previously described.

After the solid-liquid slurry has been filtered by the filter 408 to produce a filtrate, the filtrate may be transported to external from the filter 408. The filtrate may be transported by a third transfer stream 412 to external from the filter 408. The third transfer stream 412 may be the same as the second transfer stream 112 previously described.

In some non-limiting embodiments, at least a portion of the solid-liquid slurry contained within the filter 408 may be transported back to the bioreactor 404 in a first recycle stream 410. The first recycle stream 410 may be the same as the first recycle stream 110.

The second transfer stream 422 transports at least a portion of the solid-liquid slurry to the solid water separation unit 424. The solid water separation unit 424 may be any solid water separation unit known in the art and may be different from the filter 408. For example the solid water separation unit 424 may be a gravity clarifier, a dissolved air flotation unit, a hydro cyclone unit, a membrane filter, and/or the like. The solid water separation unit 424 may produce a solid lean stream. A “solid lean” stream refers to a liquid stream produced by the solid water separation unit 424 which has a TSS content that is higher than a TSS content of the final filtrate. For example the solid lean stream may have a TSS content of less than 500 mg/L, or less than 400 mg/L, or less than 300 mg/L, or less than 200 mg/L, or less than 100 mg/L, or less than 50 mg/L, or less than 30 mg/L. The solid lean stream may have a TSS content of greater than 5 mg/L, or greater than 10 mg/L, or greater than 20 mg/L, or greater than 30 mg/L.

After the solid water separation unit 424, the solid lean stream may be transported to external from the solid water separation unit 424. The solid lean stream may be transported by a fourth transfer stream 428 to external from the solid water separation unit 424. For example, the fourth transfer stream 428 may be in fluid communication with the solid water separation unit 424 and configured to transport the solid lean stream to external from the solid water separation unit 424. In some non-limiting embodiments, the fourth transfer stream 428 may include a pump and a transfer pipe, channel, port, weir, and/or the like that aid in transporting the solid lean stream from the solid water separation unit 424 to external from the solid water separation unit 424. In some non-limiting embodiments, a height difference between the solid lean stream in the solid water separation unit 424 and the solid lean stream located external from the solid water separation unit 424 may aid in transporting the solid lean stream from the solid water separation unit 424 to external from the solid water separation unit 424.

In some non-limiting embodiments, at least a portion of the solid-liquid slurry contained within the solid water separation unit 424 may be transported back to the bioreactor 404 in a second recycle stream 426. The second recycle stream 426 may be in fluid communication with the bioreactor 404 and a solid water separation unit 424, and configured to transport at least a portion of the solid-liquid slurry from the solid water separation unit 424 back to the bioreactor 404. In some non-limiting embodiments, the second recycle stream 426 may include a pump and a transfer pipe, channel, port, weir, and/or the like that aid in transporting the solid-liquid slurry from the solid water separation unit 424 back to the bioreactor 404. In some non-limiting embodiments, a height difference between the solid-liquid slurry in the solid water separation unit 424 and the solid-liquid slurry in the bioreactor 404 may aid in transporting the solid-liquid slurry from the solid water separation unit 424 back to the bioreactor 404.

In some non-limiting embodiments, a chemical additive may be added to the system 400. The chemical additive may comprise ferric chloride, aluminum sulfate, Detafloc, polyaluminum chloride such as polydiallyldimethylammonium chloride, polyacrylamide, polyethyleneimine, MPE 50, Praestol 187, Chitosan, Superfloc C-595, Superfloc C-592, Superfloc C-569, Superfloc C-581, Accepta 4222, Accepta 4223, Lupasol P, Lupasol SK, C8030, Zetag 8165, or combinations thereof. The chemical additive may include a polymer. The chemical additive may include any polymer known in the art. In some non-limiting embodiments, the polymer of the chemical additive comprises a cationic polymer. As used herein, a “cationic” polymer is a polymer that possesses positive charge(s) in the polymer backbone and/or a pendant side group. In some non-limiting embodiments the polymer of the chemical additive may comprise a high molecular weight cationic polymer. As used herein, a “high molecular weight” polymer is a polymer having a weight average molecular weight of at least 20,000 g/mol. The polymer of the chemical additive may have a molecular weight of greater than 5,000 g/mol, or greater than 10,000 g/mol, or greater than 20,000 g/mol, or greater than 50,000 g/mol, or greater than 100,000 g/mol, or greater than 150,000 g/mol, or greater than 200,000 g/mol, or greater than 250,000 g/mol, or greater than 300,000 g/mol. Weight average molecular weight can be measured using gel permeation chromatography, light-scattering measurements, and/or viscosity measurements. In some non-limiting embodiments, the polymer may comprise a cationic polymer, including but not limited to, polyaluminum chloride such as polydiallyldimethylammonium chloride, polyacrylamide, polyethyleneimine, or combinations thereof. For example, the polymer may comprise polydiallyldimethylammonium chloride. The polymer of the chemical additive may comprise MPE-50 (Nalco Company (Naperville, IL)), PRAESTOL 187 (Solenis (Wilmington, DE)), Chitosan (Tidal Vision (Bellingham, WA)), Superfloc C-595, Superfloc C-592, Superfloc C-569, Superfloc C-581 (Kemira (Helsinki, Finland)), Accepta 4222, Accepta 4223 (Accepta (Moreton, United Kingdom)), Lupasol P, Lupasol SK (BASF (Ludwigshafen, Germany)), C8030 (Yixing Bluwat Chemicals (Yixing, China)), Zetag 8165 (BASF (Ludwigshafen, Germany)), and/or the like. The chemical additive may be diluted prior to adding into the system 400. For example, the chemical additive may be diluted with water prior to adding into the system 400. The chemical additive may be added to the system 400 using any known means in the art. For example, the chemical additive may be added to the system 400 manually, e.g., by hand. As another example, a closed loop system that may include a pump may be used to add the chemical additive into the system 400. The chemical additive may be added to the solid-liquid slurry of the system 400 at the inlet zone 402, the bioreactor 404, the first transfer stream 406, the filter 408, the second transfer stream 422, the solid water separation unit 424, the first recycle stream 410, and/or the second recycle stream 426.

The mechanism for adding the chemical additive may be configured to add a specific amount of chemical additive to the solid-liquid separation system 400. For example, the mechanism for adding the chemical additive may be configured to add less than 500 mg/L, or less than 250 mg/L, or less than 100 mg/L, or less than 75 mg/L, or less than 50 mg/L, or less than 25 mg/L, or less than 12.5 mg/L, or less than 6 mg/L, or less than 5 mg/L. The solid-liquid slurry flow and its total suspended solids content can drastically fluctuate based on environmental and community conditions. The amount of chemical additive added to the solid-liquid separation system 400 may be varied between dosages in order to account for the changes in solid-liquid slurry conditions. For example, a first dose of chemical additive into the solid-liquid separation system 400 may be of a first concentration based on conditions of the solid-liquid slurry at a first time and a second dose of chemical additive may be of a second concertation based on conditions of the solid-liquid slurry at a second time. The concentration of chemical additive dosed into the solid-liquid separation system 400 may be changed between dosages in order to achieve a certain average/peak flux, total suspended solids content, and/or turbidity goal. Additionally, for a rotating filter 408, such as filter 108 of FIGS. 2-5, the rotational speed of the filter 408 may also be varied alternatively or in addition to varying the concentration of the chemical additive dosed between dosages. In some non-limiting embodiments, a flow rate and effluent turbidity meter may be used to measure the flow rate and/or turbidity of the solid-liquid slurry and determine the dosing amount of chemical additive and/or the rotation speed of the filter 408.

The chemical additive may increase both the peak flux and the average flux of the filter 408. For example, the addition of the chemical additive may increase the average flux across the dynamic membrane 414 to at least 500 L/m² h, or to at least 750 L/m² h, to at least 1,000 L/m² h, or at least 1,250 L/m² h, or at least 1,500 L/m² h, or at least 1,700 L/m² h. For example, the addition of the chemical additive may increase the average flux across the dynamic membrane 414 by at least 25%, or at least 40%, or at least 50%, or at least 60%, or at least 70%, or at least 80%, or at least 90%, or at least 100%, compared to the average flux across the dynamic membrane 414 prior to the addition of the chemical additive. When the chemical additive increases the flux, the kwh/m³ wastewater that is treated decreases. The chemical additive may also decrease the TSS content that is present in the final filtrate. For example, the addition of the chemical additive may decrease the TSS content in the final filtrate to less than 20 mg/L, or less than 15 mg/L, or less than 10 mg/L, or less than 5 mg/L, or less than 4 mg/L, or less than 3 mg/L, or less than 2.5 mg/L, or less than 2 mg/L. For example, the addition of the chemical additive may decrease the TSS content in the final filtrate by at least 25%, or by at least 30%, or by at least 35%, or by at least 40%, or by at least 45%, or by at least 50%, compared to the TSS content in the final filtrate prior to the addition of the chemical additive.

Referring to FIG. 9, a solid-liquid separation system 500 for producing a filtrate from a solid-liquid slurry is provided. The solid-liquid slurry enters the system from a source of the solid-liquid slurry to an inlet zone 502. The inlet zone 502 may be the same as the inlet zone 102 previously described.

After the solid-liquid slurry leaves the inlet zone 502, the solid-liquid slurry may enter a bioreactor 504. The bioreactor 504 may be the same as the bioreactor 104 previously described. For example, the bioreactor 504 may include various biological processes, such as an aerobic zone, an anoxic zone, and/or an anaerobic zone.

In some non-limiting embodiments, a filter 508 may be included in the same tank as the bioreactor 504. For example, after the solid-liquid slurry has undergone the biological processes of the bioreactor 504, at least a portion of the solid-liquid slurry may then enter the filter 508 without exiting the tank of the bioreactor 504.

The filter 508 may be configured to filter suspended solids from the solid-liquid slurry to produce a filtrate and cake. The filter 508 may be any filter known in the art. For example, the filter 508 may be the same as the filter 8 previously described, such as the filter 108. The filter 508 comprises a dynamic membrane 514 comprising a liquid-permeable supporting element 544 comprising a first face 556 and a second face 558 opposite the first face 556, and may include a cake layer 540 of deposited solids on the first face 556 of the liquid-permeable supporting element 544. The dynamic membrane 514 comprising the liquid permeable supporting element 544 and the cake layer 540 may be the same as the dynamic membrane 14 comprising the liquid-permeable supporting element 44 and the cake layer 40 previously described, such as the dynamic membrane 114 comprising the at least one liquid-permeable supporting element 144 and the cake layer 140 previously described.

In some non-limiting embodiments, after the solid-liquid slurry is subjected to the biological processes of the bioreactor 504, at least a portion of the solid-liquid slurry may also be transported from the bioreactor 504 in a first transfer stream 522. The first transfer stream 522 may be in fluid communication with the bioreactor 504 and a solid water separation unit 524, and configured to transport at least a portion of the solid-liquid slurry from the bioreactor 504 to the solid water separation unit 524. In some non-limiting embodiments, the first transfer stream 522 may include a pump and a transfer pipe, channel, port, weir, and/or the like that aid in transporting at least a portion of the solid-liquid slurry from the bioreactor 504 to the solid water separation unit 524. In some non-limiting embodiments, a height difference between the solid-liquid slurry in the bioreactor 504 and the solid-liquid slurry in the solid water separation unit 524 may aid in transporting at least a portion of the solid-liquid slurry from the bioreactor 504 to the solid water separation unit 524.

The first transfer stream 522 transports at least a portion of the solid-liquid slurry to the solid water separation unit 524. The solid water separation unit 524 may be the same as the solid water separation unit 424 previously described. The solid water separation unit 524 may produce a solid lean stream.

After the solid-liquid slurry has been filtered by the filter 508 to produce a filtrate, the filtrate may be transported to external from the filter 508. The filtrate may be transported by a second transfer stream 512 to external from the filter 508. The second transfer stream 512 may be the same as the second transfer stream 112 previously described.

After the solid water separation unit 524, the solid lean stream may be transported to external from the solid water separation unit 524. The solid lean stream may be transported by a third transfer stream 528 to external from the solid water separation unit 524. The third transfer stream 528 may be the same as the fourth transfer stream 428 previously described.

In some non-limiting embodiments, at least a portion of the solid-liquid slurry contained within the solid water separation unit 524 may be transported back to the bioreactor 504 in a first recycle stream 526. The first recycle stream 526 may be the same as the second recycle stream 426 previously described.

In some non-limiting embodiments, a chemical additive may be added to the system 500. The chemical additive may comprise ferric chloride, aluminum sulfate, Detafloc, polyaluminum chloride such as polydiallyldimethylammonium chloride, polyacrylamide, polyethyleneimine, MPE 50, Praestol 187, Chitosan, Superfloc C-595, Superfloc C-592, Superfloc C-569, Superfloc C-581, Accepta 4222, Accepta 4223, Lupasol P, Lupasol SK, C8030, Zetag 8165, or combinations thereof. The chemical additive may include a polymer. The chemical additive may include any polymer known in the art. In some non-limiting embodiments, the polymer of the chemical additive comprises a cationic polymer. In some non-limiting embodiments the polymer of the chemical additive may comprise a high molecular weight cationic polymer. As used herein, a “high molecular weight” polymer is a polymer having a weight average molecular weight of at least 20,000 g/mol. The polymer of the chemical additive may have a molecular weight of greater than 5,000 g/mol, or greater than 10,000 g/mol, or greater than 20,000 g/mol, or greater than 50,000 g/mol, or greater than 100,000 g/mol, or greater than 150,000 g/mol, or greater than 200,000 g/mol, or greater than 250,000 g/mol, or greater than 300,000 g/mol. Weight average molecular weight can be measured using gel permeation chromatography, light-scattering measurements, and/or viscosity measurements. In some non-limiting embodiments, the polymer may comprise a cationic polymer, including but not limited to, polyaluminum chloride such as polydiallyldimethylammonium chloride, polyacrylamide, polyethyleneimine, or combinations thereof. For example, the polymer may comprise polydiallyldimethylammonium chloride. The polymer of the chemical additive may comprise MPE-50 (Nalco Company (Naperville, IL)), PRAESTOL 187 (Solenis (Wilmington, DE)), Chitosan (Tidal Vision (Bellingham, WA)), Superfloc C-595, Superfloc C-592, Superfloc C-569, Superfloc C-581 (Kemira (Helsinki, Finland)), Accepta 4222, Accepta 4223 (Accepta (Moreton, United Kingdom)), Lupasol P, Lupasol SK (BASF (Ludwigshafen, Germany)), C8030 (Yixing Bluwat Chemicals (Yixing, China)), Zetag 8165 (BASF (Ludwigshafen, Germany)), and/or the like. The chemical additive may be diluted prior to adding into the system 500. For example, the chemical additive may be diluted with water prior to adding into the system 500. The chemical additive may be added to the system 500 using any known means in the art. For example, the chemical additive may be added to the system 500 manually, e.g., by hand. As another example, a closed loop system that may include a pump may be used to add the chemical additive into the system 500. The chemical additive may be added to the solid-liquid slurry of the system 500 at the inlet zone 502, the bioreactor 504, the filter 508, the first transfer stream 522, the solid water separation unit 524, and/or the first recycle stream 526.

The mechanism for adding the chemical additive may be configured to add a specific amount of chemical additive to the solid-liquid separation system 500. For example, the mechanism for adding the chemical additive may be configured to add less than 500 mg/L, or less than 250 mg/L, or less than 100 mg/L, or less than 75 mg/L, or less than 50 mg/L, or less than 25 mg/L, or less than 12.5 mg/L, or less than 6 mg/L, or less than 5 mg/L. The solid-liquid slurry flow and its total suspended solids content can drastically fluctuate based on environmental and community conditions. The amount of chemical additive added to the solid-liquid separation system 500 may be varied between dosages in order to account for the changes in solid-liquid slurry conditions. For example, a first dose of chemical additive into the solid-liquid separation system 500 may be of a first concentration based on conditions of the solid-liquid slurry at a first time and a second dose of chemical additive may be of a second concertation based on conditions of the solid-liquid slurry at a second time. The concentration of chemical additive dosed into the solid-liquid separation system 500 may be changed between dosages in order to achieve a certain average/peak flux, total suspended solids content, and/or turbidity goal. Additionally, for a rotating filter 508, such as filter 108 of FIGS. 2-5, the rotational speed of the filter 508 may also be varied alternatively or in addition to varying the concentration of the chemical additive dosed between dosages. In some non-limiting embodiments, a flow rate and effluent turbidity meter may be used to measure the flow rate and/or turbidity of the solid-liquid slurry and determine the dosing amount of chemical additive and/or the rotation speed of the filter 508.

The chemical additive may increase both the peak flux and the average flux of the filter 508. For example, the addition of the chemical additive may increase the average flux across the dynamic membrane 514 to at least 500 L/m² h, or to at least 750 L/m² h, to at least 1,000 L/m² h, or at least 1,250 L/m² h, or at least 1,500 L/m² h, or at least 1,700 L/m² h. For example, the addition of the chemical additive may increase the average flux across the dynamic membrane 514 by at least 25%, or at least 40%, or at least 50%, or at least 60%, or at least 70%, or at least 80%, or at least 90%, or at least 100%, compared to the average flux across the dynamic membrane 514 prior to the addition of the chemical additive. When the chemical additive increases the flux, the kwh/m³ wastewater that is treated decreases. The chemical additive may also decrease the TSS content that is present in the final filtrate. For example, the addition of the chemical additive may decrease the TSS content in the final filtrate to less than 20 mg/L, or less than 15 mg/L, or less than 10 mg/L, or less than 5 mg/L, or less than 4 mg/L, or less than 3 mg/L, or less than 2.5 mg/L, or less than 2 mg/L. For example, the addition of the chemical additive may decrease the TSS content in the final filtrate by at least 25%, or by at least 30%, or by at least 35%, or by at least 40%, or by at least 45%, or by at least 50%, compared to the TSS content in the final filtrate prior to the addition of the chemical additive.

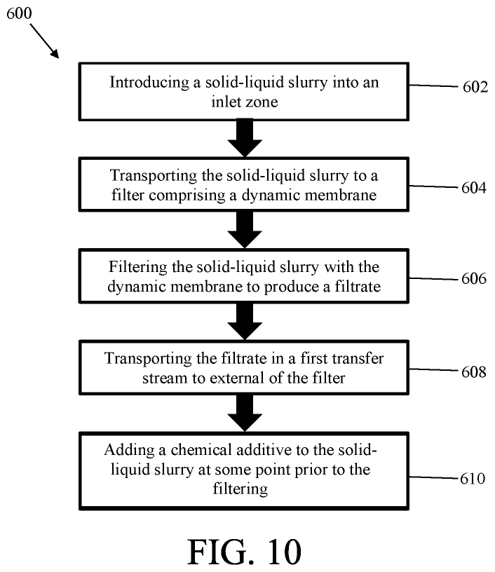

The present application also relates to a method 600 of producing a filtrate from a solid-liquid slurry. The method 600 may include various steps As shown in FIG. 10. The method 600 includes a step 602 of introducing a solid-liquid slurry into an inlet zone. The inlet zone may be the same as the inlet zone 102 previously described.

The method 600 further includes a step 604 of transporting the solid-liquid slurry to a filter comprising a dynamic membrane. The filter may be the same as the filter 8 previously described, such as the filter 108 previously described. The dynamic membrane includes a liquid-permeable supporting element and a cake layer formed of deposited solids. The dynamic membrane having a liquid-permeable supporting element and a cake layer may be the same as the dynamic membrane 14 comprising the liquid-permeable supporting element 44 and the cake layer 40 previously described, such as the dynamic membrane 114 comprising the at least one liquid-permeable supporting element 144 and the cake layer 140 previously described. The liquid-permeable supporting element may have a pore size of greater than 1 micron, or greater than 2 microns, or greater than 3 microns, or greater than 4 microns, or greater than 5 microns, or greater than 8 microns, or greater than 10 microns. The liquid-permeable supporting element may have a pore size in the range of from greater than 1 micron to 50 microns, or from greater than 1 micron to 40 microns, or from 2 microns to 40 microns, or from 2 microns to 30 microns, or from 2 microns to 25 microns, or from 2 microns to 20 microns, or from 5 microns to 20 microns. The step 604 of transporting the solid-liquid slurry to the filter may further include transporting the solid-liquid slurry from the inlet zone to a bioreactor, and transporting the solid-liquid slurry from the bioreactor to the filter. The bioreactor may be the same as the bioreactor 104 previously described. The transporting the solid-liquid slurry from the bioreactor to the filter step may comprise transporting the solid-liquid slurry from the bioreactor to the filter in a second transfer stream.

In some non-limiting embodiments, the bioreactor and the filter may be provided in the same tank. The method 600 may further include transporting at least a portion of the solid-liquid slurry in the bioreactor to a solids water separation unit in a second transfer stream. The solids water separation unit may be the same as the solids water separation unit 316, 424, or 524 previously described. The method 600 may further include separating the solid-liquid slurry in the solids water separation unit to produce a solid lean stream. The solid lean stream may be the same as the solid lean stream previously described. The method 600 may further include transporting at least a portion of the solid-liquid slurry in the solids water separation unit back to the bioreactor in a first recycle stream. The method 600 may further include transporting the solid lean stream from the solids water separation unit to external of the solids water separation unit in a third transfer stream.

The method 600 may further include transporting at least a portion of the solid-liquid slurry in the bioreactor to a solids water separation unit in a third transfer stream. The solids water separation unit may be the same as the solids water separation unit 316, 424, or 524 previously described. The method 600 may further include separating the solid-liquid slurry in the solids water separation unit to produce a solid lean stream. The solid lean stream may be the same as the solid lean stream previously described. The method 600 may further include transporting the solid lean stream to external of the solids water separation unit in a fourth transfer stream. The method 600 may further include transporting at least a portion of the solid-liquid slurry in the solids water separation unit back to the bioreactor in a second recycle stream.

The method 600 may further include transporting the solid-liquid slurry from the bioreactor to a solids water separation unit in a second transfer stream. The solids water separation unit may be the same as the solids water separation unit 316, 424, or 524 previously described. The method 600 may further include separation the solid-liquid slurry in the solids water separation unit into a first portion of solids that sinks to a bottom of the solids water separation unit and a second portion of solids that floats at a top of the solids water separation unit. The method 600 may further include transporting at least a portion of the solid-liquid slurry in the solids water separation unit to the filter in a third transfer stream. The portion of the solid-liquid slurry transported to the filter in the third transfer stream may include the second portion of solids that floats at a top of the solids water separation unit. The method 600 may further include transporting at least a portion of the solid-liquid slurry in the solids water separation unit back to the bioreactor in a second recycle stream. The portion of the solid-liquid slurry transported back to the bioreactor in the second recycle stream may include the first portion of solids that sinks to a bottom of the solids water separation unit.

The method 600 further includes a step 606 of filtering the solid-liquid slurry with the dynamic membrane to produce a filtrate. The method 600 may further include transporting at least a portion of the solid-liquid slurry in the filter back to the bioreactor in a first recycle stream.

The method further includes a step 608 of transporting the filtrate in a first transfer stream to external of the filter.

The method further includes a step 610 of adding a chemical additive to the solid-liquid slurry at some point prior to the filtering. The step 610 of adding a chemical additive to the solid-liquid slurry may comprise adding the chemical additive to the solid-liquid slurry at the inlet zone, the bioreactor, the filter, the first recycle stream between the filter and the bioreactor, and/or the second transfer stream between the bioreactor and the filter. The step 610 of adding a chemical additive to the solid-liquid slurry may comprise adding the chemical additive to the solid-liquid slurry at the inlet zone, the bioreactor, the filter, the solids water separation unit, the first recycle stream between the filter and the bioreactor, the second recycle stream between the solids water separation unit and the bioreactor, the second transfer stream between the bioreactor and the filter, and/or the third transfer stream between the bioreactor and the solids-water separation unit. The step 610 of adding a chemical additive to the solid-liquid slurry may comprise adding the chemical additive to the solid-liquid slurry at the inlet zone, the bioreactor, the filter, the solids water separation unit, the second transfer stream between the bioreactor and the solids water separation unit, the third transfer stream between the solids water separation unit and the filter, the first recycle stream between the filter and the bioreactor, and/or the second recycle stream between the solids water separation unit and the bioreactor. The step 610 of adding a chemical additive to the solid-liquid slurry may comprise adding the chemical additive to the solid-liquid slurry at the inlet zone, the bioreactor, the filter, the solids water separation unit, the second transfer stream between the bioreactor and the solids water separation unit, and/or the first recycle stream between the solids water separation unit and the bioreactor. The chemical additive may be the same as the chemical additive added to system 100 previously described.

The step 610 of adding the chemical additive to the solid-liquid slurry may comprise adding the chemical additive to the solid-liquid slurry to increase the average flux across the dynamic membrane to at least 500 L/m² h, or at least 750 L/m² h, or at least 1,000 L/m² h, or at least 1,250 L/m² h, or at least 1,500 L/m² h, or at least 1,700 L/m² h. The step 610 of adding the chemical additive to the solid-liquid slurry may comprise adding the chemical additive to the solid-liquid slurry to decrease the total suspended solids in the filtrate to less than 20 mg/L, or less than 15 mg/L, or less than 10 mg/L, or less than 5 mg/L, or less than 4 mg/L, or less than 3 mg/L, or less than 2.5 mg/L, or less than 2 mg/L. The step 610 of adding the chemical additive to the solid-liquid slurry may comprise adding less than 100 mg/L, or less than 50 mg/L, or less than 25 mg/L, or less than 12.5 mg/L, or less than 6 mg/L of chemical additive to the solid-liquid slurry.

The following Examples illustrate various embodiments of the invention. However, it is to be understood that the invention is not limited to these specific embodiments.

### EXAMPLES

### Example 1

The testing was conducted in a standard wastewater treatment facility using a TARON Rotating Disc Dynamic Filter with a pore size of 11 microns. Prior to testing, the conditions of the Taron Filter were a feed ratio of 3Q, a motor speed of 50%, a filtrate flow of 3.2 m³/h, a filtrate total suspend solids content of 1.75 mg/L, TARON bioreactor (TBR) mixed liquor suspended solids of 7,130 mg/L, and a tank mixed liquor suspended solids of 10,280 mg/L. The Taron disk rotation speed was increased to 1.32 rpm (100% rotation, 6 Hz) during the time of 8:30-10:00 am. Thereafter, a chemical additive comprising a cationic polymer was dosed into the system from 10:00 am-12:00 pm while the disk rotation speed remained at 1.32 rpm. The polymer was diluted with process water to a concentration of 25 g/L. The chemical additive comprising the cationic polymer was dosed in-line approximately 5 feet before the outlet of the inlet pipe. The chemical additive comprising the cationic polymer was dosed at a constant rate of 13 mg of solution per liter of influent flow, periodically increasing the pump speed to keep up with the increasing influent flow until the unit reached a new steady-state of operation. The dosing was stopped from 12:00-2:00 pm while the disk rotation speed continued to run at 1.32 rpm. After 2:00 μm, the filter returned to its normal operation. The testing results are tabulated below in Table 1.

TABLE 1

| Time | 8:30-10:00 am | 10:00 am-12:00 pm | 12:00-2:00 pm |
|---|---|---|---|
| Condition | 1.32 rpm, | 1.32 rpm, | 1.32 rpm, |
| | no poly, | poly added, | no poly, |
| | 100% BW | 100% BW | 100% BW |
| Flux (lmh) | 714 | 1,452 average, | 1,046 |
| | | 1,631 steady-state | |
| Flux Standard | 60 | 276 average, | 162 |
| Deviation | | 42 steady-state | |
| EFF Flow | 4.58 | 10.44 | 6.00 |
| near end of | | | |
| period (m3/h) | | | |
| TSS (mg/L) | 3.60 | 1.85 | 1.77 |
| Turb (NTU) | 2.52 | 0.714 | 1.69 |
| Tank CST (s) | 25.4 | 15.6 | 22.0 |
| Air Grid | Middle + Sides | Middle + Sides | Middle + Sides |
| Air Rate (scfh) | 1250 | 1250 | 1250 |

As shown Table 1, the dosing of the chemical additive increased the flux across the cake layer and the filter from 714 L/m² h to 1,452 L/m² h, an increase of over 50% compared to the flux prior to the chemical additive dosing. Additionally, the dosing of the chemical additive decreased the TSS content in the filtrate from 3.60 mg/L to 1.85 mg/L, a decrease in TSS of almost 50%.

### Example 2

The testing was conducted in a standard wastewater treatment facility using a TARON Rotating Disc Dynamic Filter. Prior to testing, the conditions of the Taron Filter were a feed ratio of 3Q, a motor speed of 10%, a filtrate flow of 0.95 m³/h, a filtrate total suspend solids content of 2.90 mg/L, a filtrate turbidity of 1.47 nephelometric turbidity unit (NTU), TBR mixed liquor suspended solids of 8,160 mg/L, and a tank mixed liquor suspended solids of 12,580 mg/L. To begin testing, the Taron rotating disc speed was increased to 2.36 rpm (100% rotation) from 8:30-10:00 am. Thereafter, a chemical additive comprising a cationic polymer was dosed into the filter system from 10:00 am-1:00 pm while the disc rotation speed remained at 2.36 rpm. The polymer was diluted with process water to a concentration of 25 g/L. The chemical additive comprising the cationic polymer was dosed in-line approximately 20 feet before the outlet of the inlet pipe. The chemical additive comprising the polymer was dosed at a constant rate of 13 mg of solution per liter of influent flow, periodically increasing the pump seed to keep up with the increasing influent flow until the unit reached a new steady-state of operation. The polymer dosing was stopped from 1:00-2:30 pm while the disc continued to run at 2.36 rpm. At 2:30 pm, the filter was returned to normal operation. The testing results are tabulated in Table 2.

TABLE 2

| Time | 8:30-10:07 am | 10:07 am-1:07 pm | 1:07-2:37 pm |
|---|---|---|---|
| Condition | 2.36 rpm, | 2.36 rpm, | 2.36 rpm, |
| | 70% BW | 70% BW | 70% BW |
| | | polymer dosing | |
| Flux (lmh) | 1,067 | 1,783 average | 1,290 |
| | | 1,839 steady-state | |
| Flux Standard | 114 | 254 average | 166 |
| Deviation | | 201 steady-state | |
| EFF Flow | 3.50 | 6.06 | 3.95 |
| near end of | | | |
| period (m3/h) | | | |
| TSS (mg/L) | 3.75 | 2.08 | 3.33 |
| Turbidity (NTU) | 2.96 | 1.22 | 2.81 |
| Tank CST (s) | 24.9 | 16.6 | 23.1 |
| Air Grid | Middle + | Middle + | Middle + |
| | Corners | Corners | Corners |
| Air Rate (scfh) | 1000 | 1000 | 1000 |

As shown in Table 2, the dosing of the chemical additive increased the flux across the cake layer and the filter from 1,067 L/m² h to 1,783 L/m² h.

Whereas particular examples and embodiments of this invention have been described above for purposes of illustration, it will be evident to those skilled in the art that numerous variations of the details of the present invention may be made without departing from the invention as defined in the appended claims.

The invention claimed is:

1. A solid-liquid separation system configured to produce a filtrate, comprising:
an inlet zone configured to receive a solid-liquid slurry;
a filter comprising a dynamic membrane, the dynamic membrane comprising:
a liquid-permeable supporting element having a first face, a second face opposite of the first face, and a pore size of greater than 1 micron;
a first transfer stream in fluid communication with the filter and configured to transport the filtrate to external from the filter; and
a mechanism for adding a chemical additive to the solid-liquid slurry in the solid-liquid separation system.

2. The solid-liquid separation system of claim 1, wherein the dynamic membrane further comprises a cake layer of deposited solids over at least a portion of the first face of the liquid-permeable supporting element.

3. The solid-liquid separation system of claim 1, wherein the solid-liquid slurry is water with solid particles, wastewater with solid particles, mixed liquor in activated sludge system, sludge from water treatment systems, or sludge from wastewater treatment systems.

4. The solid-liquid separation system of claim 1, further comprising:
a bioreactor configured to receive the solid-liquid slurry from the inlet zone;
a second transfer stream in fluid communication with the bioreactor and the filter and configured to transport the solid-liquid slurry from the bioreactor to the filter; and
a first recycle stream in fluid communication with the bioreactor and the filter and configured to transport at least a portion of the solid-liquid slurry from the filter back to the bioreactor;
wherein the mechanism for adding the chemical additive adds the chemical additive to the solid-liquid slurry at the inlet zone, the bioreactor, the filter, the second transfer stream, and/or the first recycle stream.

5. The solid-liquid separation system of claim 1, further comprising:
a bioreactor configured to receive the solid-liquid slurry from the inlet zone;
a second transfer stream in fluid communication with the bioreactor and the filter and configured to transport at least a portion of the solid-liquid slurry from the bioreactor to the filter;
a first recycle stream in fluid communication with the bioreactor and the filter and configured to transport at least a portion of the solid-liquid slurry from the filter back to the bioreactor;
a solids water separation unit configured to produce a solid lean stream;
a third transfer stream in fluid communication with the bioreactor and the solids water separation unit and configured to transport at least a portion of the solid-liquid slurry in the bioreactor to the solids water separation unit;
a second recycle stream in fluid communication with the solids water separation unit and the bioreactor and configured to transport at least a portion of the solid-liquid slurry in the solids water separation unit back to the bioreactor; and
a fourth transfer stream in fluid communication with the solids water separation unit and configured to transport the solid lean stream to external of the solids water separation unit;
wherein the mechanism for adding the chemical additive adds the chemical additive to the solid-liquid slurry at the inlet zone, the bioreactor, the filter, the solids water separation unit, the second transfer stream, the third transfer stream, the first recycle stream, and/or the second recycle stream.

6. The solid-liquid separation system of claim 1, further comprising:
a bioreactor configured to receive the solid-liquid slurry from the inlet zone;
a first recycle stream in fluid communication with the filter and the bioreactor and configured to transport at least a portion of the solid-liquid slurry in the filter back to the bioreactor;
a solids water separation unit, wherein a first portion of solids within the solid-liquid slurry sinks to the bottom of the solids water separation unit and a second portion of solids within the solid-liquid slurry floats in the solid-liquid slurry in the solids water separation unit;
a second transfer stream in fluid communication with the bioreactor and the solid water separation unit and configured to transport the solid-liquid slurry from the bioreactor to the solid water separation unit;
a second recycle stream in fluid communication with the bioreactor and the solids water separation unit and configured to transport at least a portion of the solid-liquid slurry from the solids water separation unit back to the bioreactor; and
a third transfer stream in fluid communication with the solids water separation unit and the filter and configured to transport at least a portion of the solid-liquid slurry from the solids water separation unit to the filter.

7. The solid-liquid separation system of claim 6, wherein the mechanism for adding the chemical additive adds the chemical additive to the solid-liquid slurry at the inlet zone, the bioreactor, the filter, the solids water separation unit, the second transfer stream, the third transfer stream, the first recycle stream, and/or the second recycle stream.

8. The solid-liquid separation system of claim 1, further comprising:
a bioreactor configured to receive the solid-liquid slurry from the inlet zone;
wherein the bioreactor and the filter are included in the same tank.

9. The solid-liquid separation system of claim 8, further comprising:
a solids water separation unit configured to produce a solid lean stream;
a second transfer stream in fluid communication with the bioreactor and the solids water separation unit and configured to transport at least a portion of the solid-liquid slurry in the bioreactor to the solids water separation unit;
a first recycle stream in fluid communication with the solids water separation unit and the bioreactor and configured to transport at least a portion of the solid-liquid slurry in the filter back to the bioreactor; and
a third transfer stream in fluid communication with the solids water separation unit and configured to transport the solid lawn-lean stream to external of the solids water separation unit;
wherein the mechanism for adding the chemical additive adds the chemical additive to the solid-liquid stream at the inlet zone, the bioreactor, the filter, the solids water separation unit, the second transfer stream, and/or the first recycle stream.

10. The solid-liquid separation system of claim 1, wherein the chemical additive comprises a polymer.

11. The solid-liquid separation system of claim 10, wherein the polymer comprises a cationic polymer.

12. The solid-liquid separation system of claim 11, wherein the cationic polymer has a molecular weight of greater than 20,000 g/mol.

13. The solid-liquid separation system of claim 11, wherein the cationic polymer has a molecular weight of greater than 100,000 g/mol.

14. (canceled)

15. The solid-liquid separation system of claim 11, wherein the cationic polymer comprises polydiallyldimethylammonium chloride.

16. The solid-liquid separation system of claim 1, wherein the mechanism for adding the chemical additive is configured to add the chemical additive to increase the flux across the dynamic membrane to at least 500 L/m² h.

17-20. (canceled)

21. The solid-liquid separation system of claim 1, wherein the mechanism for adding the chemical additive is configured to add the chemical additive to decrease the total suspended solids in the filtrate to less than 20 mg/L.

22-23. (canceled)

24. The solid-liquid separation system of claim 1, wherein the mechanism for adding the chemical additive is configured to add the chemical additive to decrease the total suspended solids in the filtrate to less than 20 mg/L.

25-28. (canceled)

29. The solid-liquid separation system of claim 1, wherein the pore size of the liquid-permeable supporting element is larger than 5 microns.

30-59. (canceled)

60. A solid-liquid separation system configured to produce a filtrate, Comprising:
an inlet zone configured to receive a solid-liquid slurry;
a tank configured to receive the solid-liquid slurry from the inlet zone;
a filter comprising a dynamic membrane, the dynamic membrane comprising:
a liquid-permeable supporting element having a first face, a second face opposite of the first face, and a pore size of greater than 1 micron;
a first transfer stream in fluid communication with the filter and configured to transport the filtrate to external from the filter;
a second transfer stream in fluid communication with the tank and the filter and configured to transport the solid-liquid slurry from the tank to the filter; and
a mechanism for adding a chemical additive to the solid-liquid slurry in the solid-liquid separation system.

61. The solid-liquid separation system of claim 60, wherein the tank comprises a bioreactor.
